(19) United States
(12) Patent Application Publication
(10) Pub. No.: US 2014/0176591 A1
(43) Pub. Date: Jun. 26, 2014

(54) LOW-LATENCY FUSING OF COLOR IMAGE DATA

(71) Applicants: Georg Klein, Seattle, WA (US); Ashraf Ayman Michail, Kirkland, WA (US); Timothy R. Osborne, Woodinville, WA (US); Tuan Wong, Bellevue, WA (US); Douglas Kevin Service, Bothell, WA (US); Sujeet Mehta, Kirkland, WA (US); Bruno Silva, Clyde Hill, WA (US); Arthur C. Tomlin, Kirkland, WA (US)

(72) Inventors: Georg Klein, Seattle, WA (US); Ashraf Ayman Michail, Kirkland, WA (US); Timothy R. Osborne, Woodinville, WA (US); Tuan Wong, Bellevue, WA (US); Douglas Kevin Service, Bothell, WA (US); Sujeet Mehta, Kirkland, WA (US); Bruno Silva, Clyde Hill, WA (US); Arthur C. Tomlin, Kirkland, WA (US)

(21) Appl. No.: 13/727,040

(22) Filed: Dec. 26, 2012

(51) Int. Cl. G09G 5/02

(52) U.S. Cl. CPC G09G 5/026
USPC 345/589

(57) ABSTRACT

A system and method are disclosed for fusing virtual content with real content to provide a mixed reality experience for one or more users. The system includes a mobile display device communicating with a hub computing system. In examples, the mobile display device includes a color sequential display for displaying an image over a number of color channels. Image data on respective color channels may be adjusted based on a predicted position of the mobile display device at a time the sequential color display projects the image.

### BACKGROUND

Mixed reality is a technology that allows virtual imagery to be fused with the real world to produce a new environment where a user can see both physical and virtual objects in real time. A see-through, head mounted, mixed reality display device may be worn by a user to view the mixed imagery of real objects and virtual objects displayed in the user's field of view.

A significant drawback of conventional mixed reality systems is latency. When a user turns his head, the user's view of the real world changes pretty much instantaneously. However, in conventional mixed reality systems, it takes time for the sensors to sense the new image data and render the graphics image for display to the head mounted display worn by the user. Certain display devices for displaying virtual images to users operate using a sequential color display. These displays transmit primary color information (red, blue, green) in successive images at a high frame rate, and rely on the human vision system to fuse the successive images into a cohesive color picture. However, due to latency in a display system, where a user turns his head, the successive images may be displayed by the head mounted display at different locations, thus resulting in color break-up of the image.

### SUMMARY

The technology described herein provides a system for fusing virtual content with real content to provide a mixed reality experience for one or more users. The system includes a mobile display device communicating with a hub computing system. In embodiments, the mobile display device includes a color sequential display for displaying an image over a number of color channels. Image data on respective color channels is adjusted based on a predicted position of the mobile display device at a time the sequential color display projects the image.

Each mobile display device may include a mobile processing unit coupled to a head mounted display device (or other suitable apparatus) having a display element. In embodiments, each user may wear a head mounted display device which allows the user to look through the display element at the room. The display device allows actual direct viewing of the room and the real world objects in the room through the display element. The color sequential display is provided in the head mounted display to project virtual images into the field of view of the user such that the virtual images appear to be in the room. The system automatically tracks where the user is looking so that the system can determine where to insert the virtual image in the field of view of the user. Once the system knows where to project the virtual image, the image is projected using the display element.

In embodiments, the hub computing system and one or more of the processing units may cooperate to build a model of the environment including the x, y, z Cartesian positions of all users, real world objects and virtual three-dimensional object in the room or other environment. The positions of each head mounted display device worn by the users in the environment may be calibrated to the model of the environment and to each other. This allows the system to determine each user's line of sight and field of view of the environment. Thus, a virtual image may be displayed to each user, but the system determines the display of the virtual image from each user's perspective, adjusting the virtual image for parallax and any occlusions from or by other objects in the environment. The model of the environment, referred to herein as a scene map, as well as all tracking of the user's field of view and objects in the environment may be generated by the hub and computing device and the one or more processing elements working in tandem. In further embodiments, the one or more processing units may perform all system operations and the hub computing system may be omitted.

It takes time to generate and update the positions of all objects in an environment and it takes time to render the virtual objects from the perspective of each user. These operations thus introduce inherent latency in the system. By predicting the field of view of the head mounted display at a time the image data on the respective color channels is to be displayed, the image data for the respective color channels may be adjusted, or reprojected, to account for this inherent latency. As such, the images displayed to the user on the respective color channels fuse into a single, cohesive full color image.

In embodiments, the present technology relates to a system for presenting a mixed reality experience, the system comprising: a display device including a color sequential display for projecting a virtual object in two or more color channels; a sensor for sensing positions of the display device; and one or more processors for determining image data for the virtual object on each of the two or more color channels for the color sequential display to project the virtual object, the one or more processors predicting a position of the display device at a time the color sequential display is to project the virtual object based on input from the sensor, the one or more processors adjusting the image data for the virtual object on first and second color channels of the two or more color channels, independently of each other, based on the predicted position of the display device at the time the color sequential display is to project the virtual object.

In further embodiments, the present technology relates to a system for presenting a mixed reality experience, the system comprising: a head mounted display device including a color sequential display for projecting a virtual object using first, second and third color channels; a plurality of sensors for sensing positions of the display device, the plurality of sensors comprising an inertial measurement unit for sensing movement of the head mounted display device and at least one image capture device; and one or more processors for determining a three-dimensional map of the environment in which the system is used based on data from the plurality of sensors, the one or more processors determining at a time t₁ a position at which to project the virtual object via the first color channel, the one or more processors determining at a time t₂, after t₁, a position at which to project the virtual object via the second color channel, the one or more processors determining at a time t₃, after t₂, a position at which to project the virtual object via the third color channel, the one or more processors predicting a position of the display device at a time t₄ when the color sequential display is to project the virtual object, the one or more processors adjusting the image data for the virtual object on the first, second and third color channels, independently of each other, based on the predicted position of the display device at the time t₄.

In further embodiments, the present technology relates to a method of displaying an image using a display device including a color sequential display, the method comprising: (a) determining a view of the display device at a first time; (b) determining image data to render based on the view determined in said step (a); (c) predicting an updated view of the display device at a second time later than the first time; (d) applying one or more transforms to image data for the color channels of the color sequential display to adjust the image data for the color channels based on the updated view predicted in said step (b), image data for a first color channel adjusted differently than image data for a second color channel; and (e) rendering the image for the color channels.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an illustration of example components of one embodiment of a system for presenting a mixed reality environment to one or more users.

FIG. 2 is a perspective view of one embodiment of a head mounted display unit.

FIG. 3 is a side view of a portion of one embodiment of a head mounted display unit.

FIG. 4 is a block diagram of one embodiment of the components of a head mounted display unit.

FIG. 5 is a block diagram of one embodiment of the components of a processing unit associated with a head mounted display unit.

FIG. 6 is a block diagram of one embodiment of the components of a hub computing system used with head mounted display unit.

FIG. 7 is a block diagram of one embodiment of a computing system that can be used to implement the hub computing system described herein.

FIG. 8 is an illustration of example components of a mobile embodiment of a system for presenting a mixed reality environment to one or more users in an outdoors setting.

FIG. 9 is a flowchart showing the operation and collaboration of the hub computing system, one or more processing units and one or more head mounted display units of the present system.

FIGS. 10-15A are more detailed flowcharts of examples of various steps shown in the flowchart of FIG. 9.

FIG. 16 illustrates image data for respective color channels being corrected to an aligned position at an estimated time of display.

FIGS. 17 and 18 illustrate a pair of exemplary expanded fields of view according to a further embodiment of the present technology.

### DETAILED DESCRIPTION

A system is disclosed herein for preventing color breakdown in a system using a sequential color display by predicting user pose and adjusting respective color channels accordingly. The present system may for example be used in a mixed reality environment which fuses virtual objects with real objects. In one embodiment, the system includes a head mounted display device and a processing unit in communication with the head mounted display device worn by each of one or more users. The head mounted display device includes a display that allows a direct view of real world objects through the display. The system can also project virtual images on the display that are viewable by the person wearing the head mounted display device while that person is also viewing real world objects through the display. Various sensors are used to detect position and orientation of the one or more users in order to determine where to project the virtual images.

One or more of the sensors are used to scan the neighboring environment and build a model of the scanned environment. Using the model, a virtual image is added to a view of the model at a location, possibly together with one or more real world objects that are also part of the model. The system automatically tracks where the one or more users are looking so that the system can figure out the users' field of view through the display of the head mounted display device. User pose including head position can be tracked using any of various sensors including depth sensors, image sensors, inertial sensors, eye position sensors, etc.

In embodiments, the head mounted display may use a microdisplay for generating the projected virtual images. The microdisplay may be color sequential display that generates a first color image in a first sub-frame, a second color image in a second sub-frame and a third color in a third sub-frame. In embodiments, these colors may be red, green and blue, generated in any order of sub-frames. In further embodiments, there may be more or less than three colors provided in successive sub-frames. The sub-frames are displayed by the microdisplay to the user at speeds such that the human vision system fuses the colors of the successive sub-frames together into a single color image.

As noted in the Background section, given that the color sub-frames are generated at different times, they may be spatially out of sync, such as for example where a user is turning his head and the field of view (FOV) is changing. Using current and past data relating to a model of the environment (including users, real world objects and virtual objects) and a user's FOV of that environment, the system extrapolates into the future to predict the model of the environment and a user's field of view of that environment at a time when the image of the environment is to be displayed to the user. Using this prediction, transforms may be applied to the respective color sub-frames so that each color sub-frame is spatially aligned at the time the sub-frames are projected by the microdisplay.

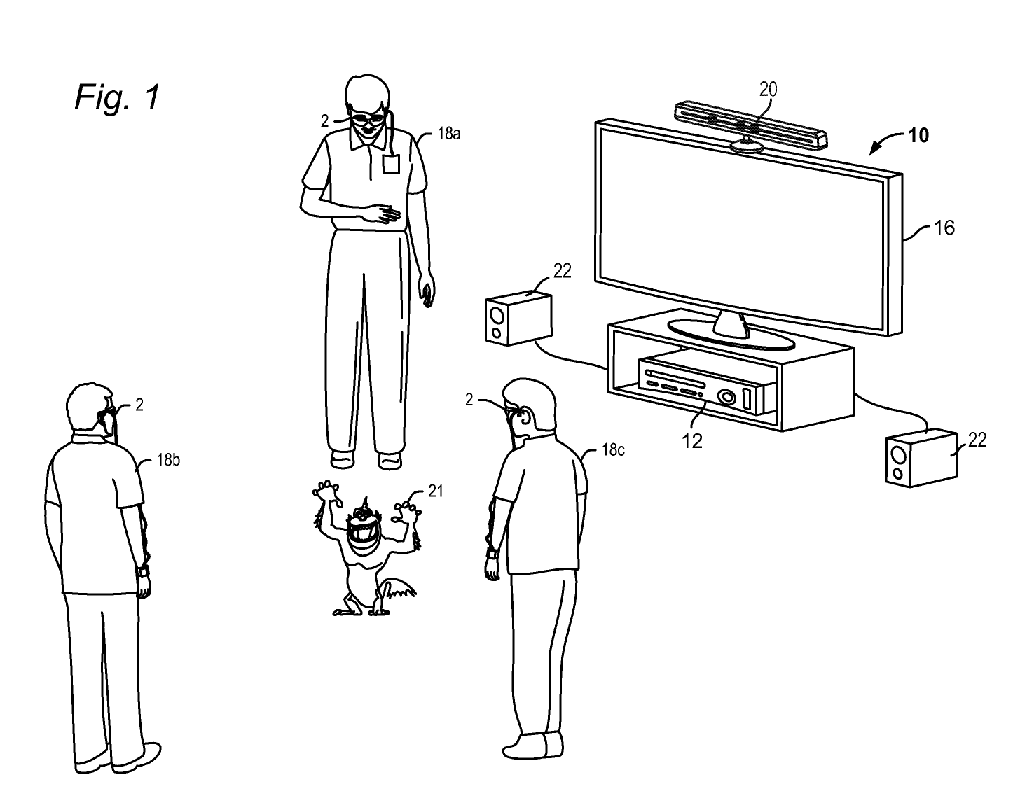

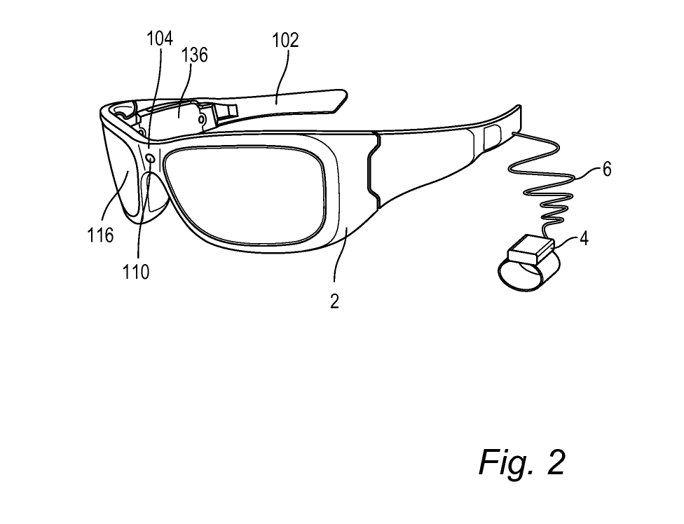

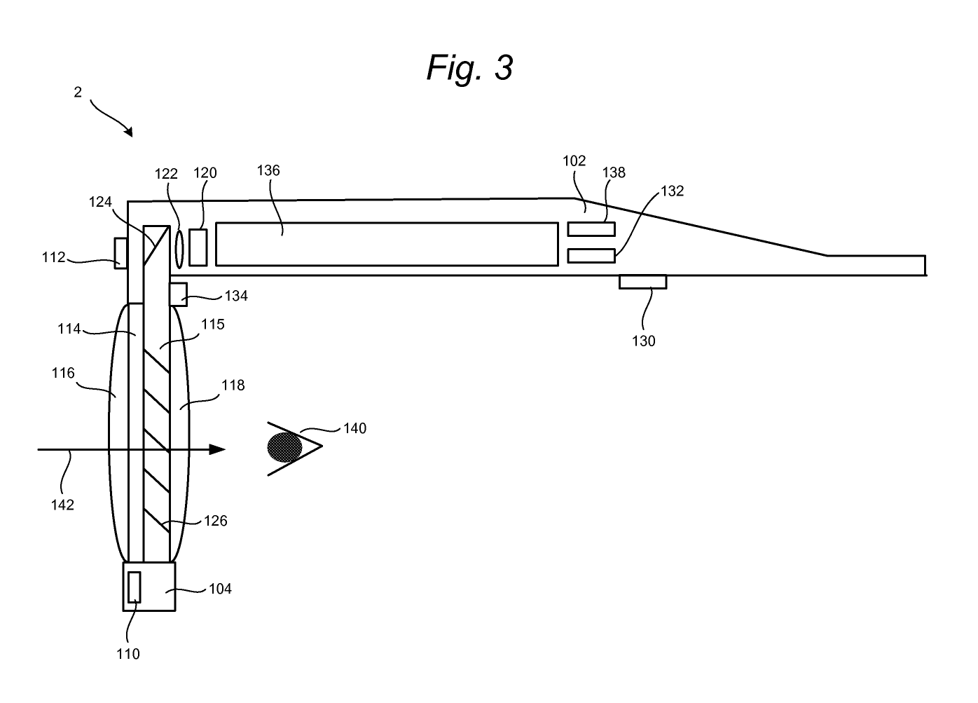

FIG. 1 illustrates a system 10 for providing a mixed reality experience by fusing virtual content into real content. FIG. 1 shows a number of users 18a, 18b and 18c each wearing a head mounted display device 2. As seen in FIGS. 2 and 3, each head mounted display device 2 may be in communication with its own processing unit 4 via wire 6. In other embodiments, head mounted display device 2 communicates with processing unit 4 via wireless communication. Head mounted display device 2, which in one embodiment is in the shape of glasses, is worn on the head of a user so that the user can see through a display and thereby have an actual direct view of the space in front of the user. The use of the term “actual direct view” refers to the ability to see the real world objects directly with the human eye, rather than seeing created image representations of the objects. For example, looking through glass at a room allows a user to have an actual direct view of the room, while viewing a video of a room on a television is not an actual direct view of the room. More details of the head mounted display device 2 are provided below.

In one embodiment, processing unit 4 is a small, portable device for example worn on the user's wrist or stored within a user's pocket. The processing unit may for example be the size and form factor of a cellular telephone, though it may be other shapes and sizes in further examples. The processing unit 4 may include much of the computing power used to operate head mounted display device 2. In embodiments, the processing unit 4 communicates wirelessly (e.g., Wi-Fi, Bluetooth, infra-red, or other wireless communication means) to one or more hub computing systems 12. As explained hereinafter, hub computing system 12 may be omitted in further embodiments to provide a completely mobile mixed reality experience using just the head mounted displays and processing units 4.

Hub computing system 12 may be a computer, a gaming system or console, or the like. According to an example embodiment, the hub computing system 12 may include hardware components and/or software components such that hub computing system 12 may be used to execute applications such as gaming applications, non-gaming applications, or the like. In one embodiment, hub computing system 12 may include a processor such as a standardized processor, a specialized processor, a microprocessor, or the like that may execute instructions stored on a processor readable storage device for performing the processes described herein.

Hub computing system 12 further includes a capture device 20 for capturing image data from portions of a scene within its FOV. As used herein, a scene is the environment in which the users move around, which environment is captured within the FOV of the capture device 20 and/or the FOV of each head mounted display device 2. FIG. 1 shows a single capture device 20, but there may be multiple capture devices in further embodiments which cooperate to collectively capture image data from a scene within the composite FOVs of the multiple capture devices 20. Capture device 20 may include one or more cameras that visually monitor the one or more users 18a, 18b, 18c and the surrounding space such that gestures and/or movements performed by the one or more users, as well as the structure of the surrounding space, may be captured, analyzed, and tracked to perform one or more controls or actions within the application and/or animate an avatar or on-screen character.

Hub computing system 12 may be connected to an audiovisual device 16 such as a television, a monitor, a high-definition television (HDTV), or the like that may provide game or application visuals. For example, hub computing system 12 may include a video adapter such as a graphics card and/or an audio adapter such as a sound card that may provide audiovisual signals associated with the game application, non-game application, etc. The audiovisual device 16 may receive the audiovisual signals from hub computing system 12 and may then output the game or application visuals and/or audio associated with the audiovisual signals. According to one embodiment, the audiovisual device 16 may be connected to hub computing system 12 via, for example, an S-Video cable, a coaxial cable, an HDMI cable, a DVI cable, a VGA cable, a component video cable, RCA cables, etc. In one example, audiovisual device 16 includes internal speakers. In other embodiments, audiovisual device 16 and hub computing system 12 may be connected to external speakers 22.

Hub computing system 12, with capture device 20, may be used to recognize, analyze, and/or track human (and other types of) targets. For example, one or more of the users 18a, 18b and 18c wearing head mounted display devices 2 may be tracked using the capture device 20 such that the gestures and/or movements of the users may be captured to animate one or more avatars or on-screen characters. The movements may also or alternatively be interpreted as controls that may be used to affect the application being executed by hub computing system 12. The hub computing system 12, together with the head mounted display devices 2 and processing units 4, may also together provide a mixed reality experience where one or more virtual images, such as virtual image 21 in FIG. 1, may be mixed together with real world objects in a scene.

FIGS. 2 and 3 show perspective and side views of the head mounted display device 2. FIG. 3 shows the right side of head mounted display device 2, including a portion of the device having temple 102 and nose bridge 104. Built into nose bridge 104 is a microphone 110 for recording sounds and transmitting that audio data to processing unit 4, as described below. At the front of head mounted display device 2 is room-facing video camera 112 that can capture video and still images. Those images are transmitted to processing unit 4, as described below.

A portion of the frame of head mounted display device 2 will surround a display (that includes one or more lenses). In order to show the components of head mounted display device 2, a portion of the frame surrounding the display is not depicted. The display includes a light-guide optical element 115, opacity filter 114, see-through lens 116 and see-through lens 118. In one embodiment, opacity filter 114 is behind and aligned with see-through lens 116, light-guide optical element 115 is behind and aligned with opacity filter 114, and see-through lens 118 is behind and aligned with light-guide optical element 115. See-through lenses 116 and 118 are standard lenses used in eye glasses and can be made to any prescription (including no prescription). In one embodiment, see-through lenses 116 and 118 can be replaced by a variable prescription lens. In some embodiments, head mounted display device 2 will include one see-through lens or no see-through lenses. In another alternative, a prescription lens can go inside light-guide optical element 115. Opacity filter 114 filters out natural light (either on a per pixel basis or uniformly) to enhance the contrast of the virtual imagery. Light-guide optical element 115 channels artificial light to the eye. More details of opacity filter 114 and light-guide optical element 115 are provided below.

Mounted to or inside temple 102 is an image source, which (in one embodiment) includes microdisplay 120 for projecting a virtual image and lens 122 for directing images from microdisplay 120 into light-guide optical element 115. In one embodiment, lens 122 is a collimating lens. As explained below, microdisplay 120 may be a color sequential imaging device such as a liquid crystal on silicon (LCoS) or digital light processing (DLP) device.

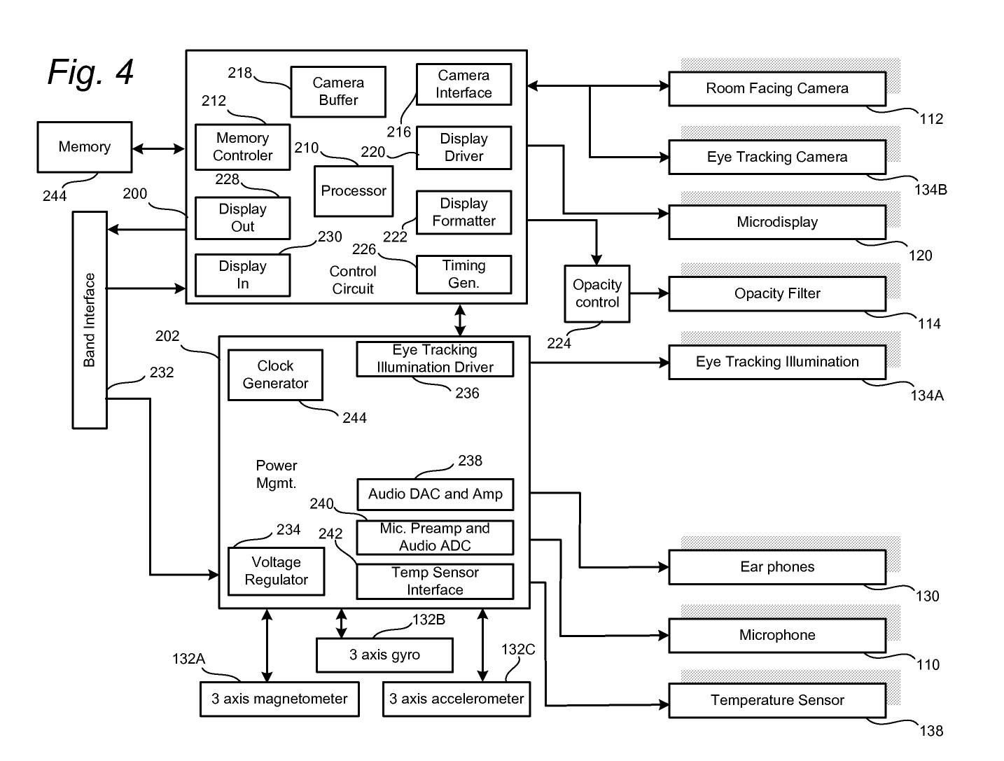

Control circuits 136 provide various electronics that support the other components of head mounted display device 2. More details of control circuits 136 are provided below with respect to FIG. 4. Inside or mounted to temple 102 are earphones 130, inertial sensors 132 and temperature sensor 138. In one embodiment shown in FIG. 4, inertial sensors 132 include a three axis magnetometer 132A, three axis gyro 132B and three axis accelerometer 132C. The inertial sensors 132 are for sensing position, orientation, and sudden accelerations (pitch, roll and yaw) of head mounted display device 2. The inertial sensors may collectively be referred to below as the inertial measurement unit 132 or IMU 132. The IMU 132 may include other inertial sensors in addition to or instead of magnetometer 132A, gyro 132B and accelerometer 132C.

Microdisplay 120 projects an image through lens 122. There are different image generation technologies that can be used to implement microdisplay 120. For example, microdisplay 120 can also be implemented using a reflective technology for which external light is reflected and modulated by an optically active material. The illumination may be forward lit by an RGB source. As noted, DLP and LCoS are examples which may be used for microdisplay 120.

Light-guide optical element 115 transmits light from microdisplay 120 to the eye 140 of the user wearing head mounted display device 2. Light-guide optical element 115 also allows light from in front of the head mounted display device 2 to be transmitted through light-guide optical element 115 to eye 140, as depicted by arrow 142, thereby allowing the user to have an actual direct view of the space in front of head mounted display device 2 in addition to receiving a virtual image from microdisplay 120. Thus, the walls of light-guide optical element 115 are see-through. Light-guide optical element 115 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar substrate comprising light-guide optical element 115 by internal reflection. After several reflections off the surfaces of the substrate, the trapped light waves reach an array of selectively reflecting surfaces 126. Note that just one of the five surfaces is labeled 126 to prevent over-crowding of the drawing. Reflecting surfaces 126 couple the light waves incident upon those reflecting surfaces out of the substrate into the eye 140 of the user.

As different light rays will travel and bounce off the inside of the substrate at different angles, the different rays will hit the various reflecting surfaces 126 at different angles. Therefore, different light rays will be reflected out of the substrate by different ones of the reflecting surfaces. The selection of which light rays will be reflected out of the substrate by which surface 126 is engineered by selecting an appropriate angle of the surfaces 126. More details of a light-guide optical element can be found in United States Patent Publication No. 2008/0285140, entitled “Substrate-Guided Optical Devices,” published on Nov. 20, 2008, incorporated herein by reference in its entirety. In one embodiment, each eye will have its own light-guide optical element 115. When the head mounted display device 2 has two light-guide optical elements, each eye can have its own microdisplay 120 that can display the same image in both eyes or different images in the two eyes. In another embodiment, there can be one light-guide optical element which reflects light into both eyes.

Opacity filter 114, which is aligned with light-guide optical element 115, selectively blocks natural light, either uniformly or on a per-pixel basis, from passing through light-guide optical element 115. Details of an opacity filter such as filter 114 are provided in U.S. patent application Ser. No. 12/887,426, entitled “Opacity Filter For See-Through Mounted Display,” filed on Sep. 21, 2010, incorporated herein by reference in its entirety. However, in general, an embodiment of the opacity filter 114 can be a see-through LCD panel, an electrochromic film, or similar device which is capable of serving as an opacity filter. Opacity filter 114 can include a dense grid of pixels, where the light transmissivity of each pixel is individually controllable between minimum and maximum transmissivities. While a transmissivity range of 0-100% is ideal, more limited ranges are also acceptable, such as for example about 50% to 90% per pixel, up to the resolution of the LCD.

A mask of alpha values can be used from a rendering pipeline, after z-buffering with proxies for real-world objects. When the system renders a scene for the augmented reality display, it takes note of which real-world objects are in front of which virtual objects as explained below. If a virtual object is in front of a real-world object, then the opacity should be on for the coverage area of the virtual object. If the virtual object is (virtually) behind a real-world object, then the opacity should be off, as well as any color for that pixel, so the user will just see the real-world object for that corresponding area (a pixel or more in size) of real light. Coverage would be on a pixel-by-pixel basis, so the system could handle the case of part of a virtual object being in front of a real-world object, part of the virtual object being behind the real-world object, and part of the virtual object being coincident with the real-world object. Displays capable of going from 0% to 100% opacity at low cost, power, and weight are advantageous for this use. Moreover, the opacity filter can be rendered in color, such as with a color LCD or with other displays such as organic LEDs, to provide a wide field of view.

Head mounted display device 2 also includes a system for tracking the position of the user's eyes. As will be explained below, the system will track the user's position and orientation so that the system can determine the field of view of the user. However, a human will not perceive everything in front of them. Instead, a user's eyes will be directed at a subset of the environment. Therefore, in one embodiment, the system will include technology for tracking the position of the user's eyes in order to refine the measurement of the field of view of the user. For example, head mounted display device 2 includes eye tracking assembly 134 (see FIG. 3), which will include an eye tracking illumination device 134A and eye tracking camera 134B (see FIG. 4). In one embodiment, eye tracking illumination device 134A includes one or more infrared (IR) emitters, which emit IR light toward the eye. Eye tracking camera 134B includes one or more cameras that sense the reflected IR light. The position of the pupil can be identified by known imaging techniques which detect the reflection of the cornea. For example, see U.S. Pat. No. 7,401,920, entitled “Head Mounted Eye Tracking and Display System”, issued Jul. 22, 2008, incorporated herein by reference. Such a technique can locate a position of the center of the eye relative to the tracking camera. Generally, eye tracking involves obtaining an image of the eye and using computer vision techniques to determine the location of the pupil within the eye socket. In one embodiment, it is sufficient to track the location of one eye since the eyes usually move in unison. However, it is possible to track each eye separately.

In one embodiment, the system will use four IR LEDs and four IR photo detectors in rectangular arrangement so that there is one IR LED and IR photo detector at each corner of the lens of head mounted display device 2. Light from the LEDs reflect off the eyes. The amount of infrared light detected at each of the four IR photo detectors determines the pupil direction. That is, the amount of white versus black in the eye will determine the amount of light reflected off the eye for that particular photo detector. Thus, the photo detector will have a measure of the amount of white or black in the eye. From the four samples, the system can determine the direction of the eye.

Another alternative is to use four infrared LEDs as discussed above, but one infrared CCD on the side of the lens of head mounted display device 2. The CCD will use a small mirror and/or lens (fish eye) such that the CCD can image up to 75% of the visible eye from the glasses frame. The CCD will then sense an image and use computer vision to find the image, much like as discussed above. Thus, although FIG. 3 shows one assembly with one IR transmitter, the structure of FIG. 3 can be adjusted to have four IR transmitters and/or four IR sensors. More or less than four IR transmitters and/or four IR sensors can also be used.

Another embodiment for tracking the direction of the eyes is based on charge tracking. This concept is based on the observation that a retina carries a measurable positive charge and the cornea has a negative charge. Sensors are mounted by the user's ears (near earphones 130) to detect the electrical potential while the eyes move around and effectively read out what the eyes are doing in real time. Other embodiments for tracking eyes can also be used.

FIG. 3 shows half of the head mounted display device 2. A full head mounted display device would include another set of see-through lenses, another opacity filter, another light-guide optical element, another microdisplay 120, another lens 122, room-facing camera, eye tracking assembly, micro display, earphones, and temperature sensor.

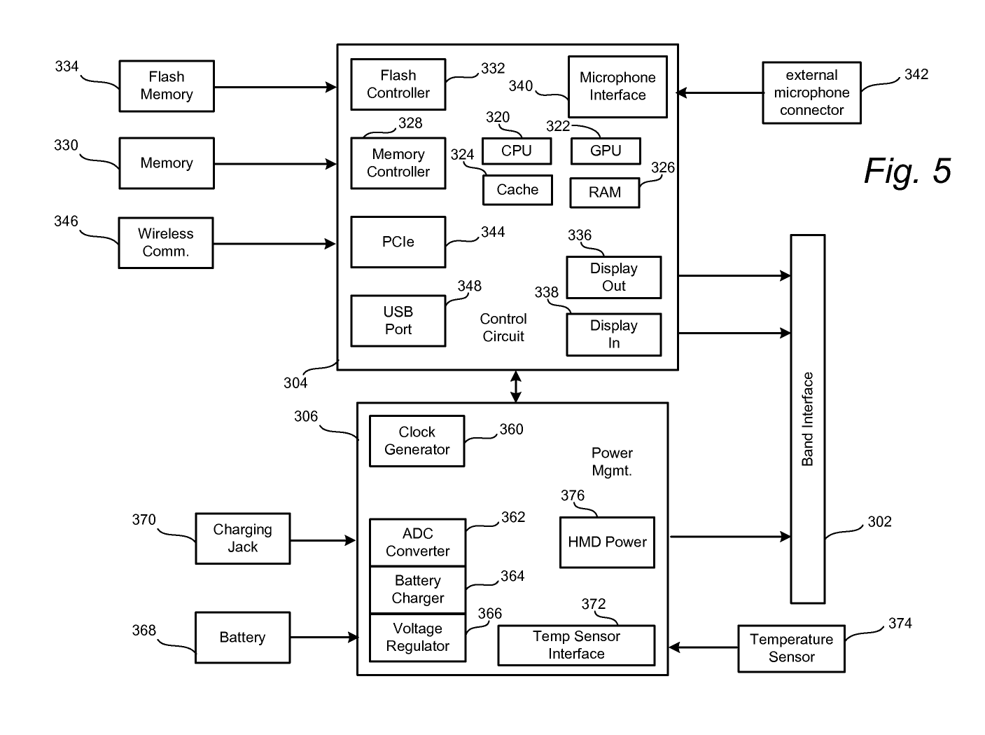

FIG. 4 is a block diagram depicting the various components of head mounted display device 2. FIG. 5 is a block diagram describing the various components of processing unit 4. Head mounted display device 2, the components of which are depicted in FIG. 4, is used to provide a mixed reality experience to the user by fusing one or more virtual images seamlessly with the user's view of the real world. Additionally, the head mounted display device components of FIG. 4 include many sensors that track various conditions. Head mounted display device 2 will receive instructions about the virtual image from processing unit 4 and will provide the sensor information back to processing unit 4. Processing unit 4, the components of which are depicted in FIG. 4, will receive the sensory information from head mounted display device 2 and will exchange information and data with the hub computing system 12 (FIG. 1). Based on that exchange of information and data, processing unit 4 will determine where and when to provide a virtual image to the user and send instructions accordingly to the head mounted display device of FIG. 4.

Some of the components of FIG. 4 (e.g., room-facing camera 112, eye tracking camera 134B, microdisplay 120, opacity filter 114, eye tracking illumination device 134A, earphones 130, and temperature sensor 138) are shown in shadow to indicate that there are two of each of those devices, one for the left side and one for the right side of head mounted display device 2. FIG. 4 shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230.

In one embodiment, all of the components of control circuit 200 are in communication with each other via dedicated lines or one or more buses. In another embodiment, each of the components of control circuit 200 is in communication with processor 210. Camera interface 216 provides an interface to the two room-facing cameras 112 and stores images received from the room-facing cameras in camera buffer 218. Display driver 220 will drive microdisplay 120. Display formatter 222 provides information, about the virtual image being displayed on microdisplay 120, to opacity control circuit 224, which controls opacity filter 114. Timing generator 226 is used to provide timing data for the system. Display out 228 is a buffer for providing images from room-facing cameras 112 to the processing unit 4. Display in 230 is a buffer for receiving images such as a virtual image to be displayed on microdisplay 120. Display out 228 and display in 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242 and clock generator 244. Voltage regulator 234 receives power from processing unit 4 via band interface 232 and provides that power to the other components of head mounted display device 2. Eye tracking illumination driver 236 provides the IR light source for eye tracking illumination device 134A, as described above. Audio DAC and amplifier 238 output audio information to the earphones 130. Microphone preamplifier and audio ADC 240 provides an interface for microphone 110. Temperature sensor interface 242 is an interface for temperature sensor 138. Power management unit 202 also provides power and receives data back from three axis magnetometer 132A, three axis gyro 132B and three axis accelerometer 132C.

FIG. 5 is a block diagram describing the various components of processing unit 4. FIG. 5 shows control circuit 304 in communication with power management circuit 306. Control circuit 304 includes a central processing unit 320, graphics processing unit 322, cache 324, RAM 326, memory controller 328 in communication with memory 330 (e.g., D-RAM), flash memory controller 332 in communication with flash memory 334 (or other type of non-volatile storage), display out buffer 336 in communication with head mounted display device 2 via band interface 302 and band interface 232, display in buffer 338 in communication with head mounted display device 2 via band interface 302 and band interface 232, microphone interface 340 in communication with an external microphone connector 342 for connecting to a microphone, PCI express interface for connecting to a wireless communication device 346, and USB port(s) 348. In one embodiment, wireless communication device 346 can include a Wi-Fi enabled communication device, BlueTooth communication device, infrared communication device, etc. The USB port can be used to dock the processing unit 4 to hub computing system 12 in order to load data or software onto processing unit 4, as well as charge processing unit 4. In one embodiment, CPU 320 and GPU 322 are the main workhorses for determining where, when and how to insert virtual three-dimensional objects into the view of the user. More details are provided below.

Power management circuit 306 includes clock generator 360, analog to digital converter 362, battery charger 364, voltage regulator 366, head mounted display power source 376, and temperature sensor interface 372 in communication with temperature sensor 374 (possibly located on the wrist band of processing unit 4). Analog to digital converter 362 is used to monitor the battery voltage, the temperature sensor and control the battery charging function. Voltage regulator 366 is in communication with battery 368 for supplying power to the system. Battery charger 364 is used to charge battery 368 (via voltage regulator 366) upon receiving power from charging jack 370. HMD power source 376 provides power to the head mounted display device 2.

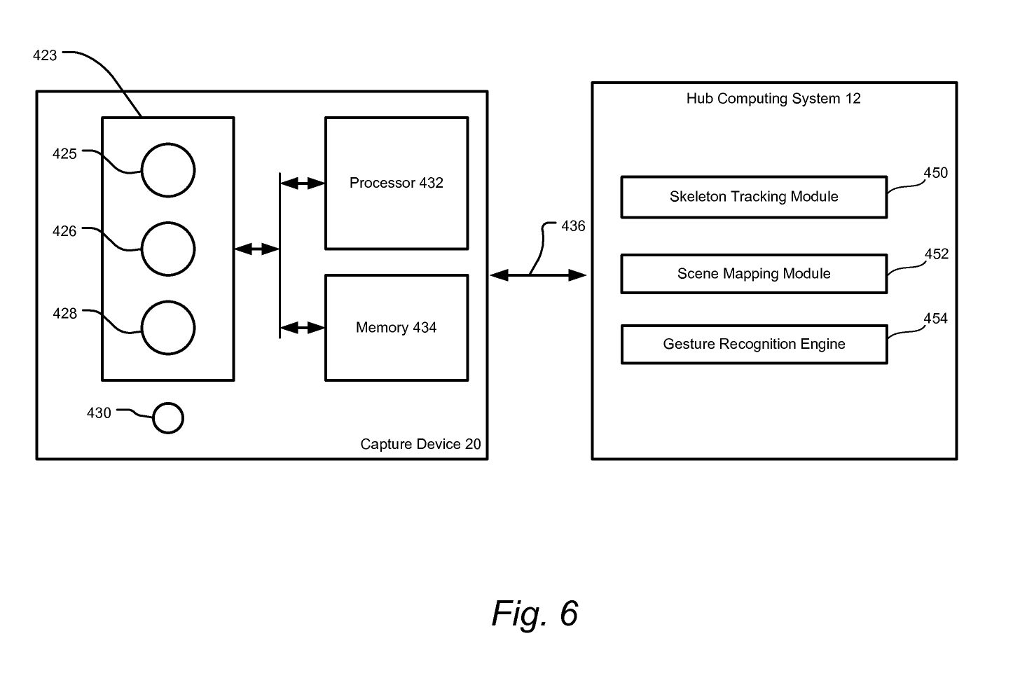

FIG. 6 illustrates an example embodiment of hub computing system 12 with a capture device 20. According to an example embodiment, capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 6, capture device 20 may include a camera component 423. According to an example embodiment, camera component 423 may be or may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Camera component 423 may include an infra-red (IR) light component 425, a three-dimensional (3-D) camera 426, and an RGB (visual image) camera 428 that may be used to capture the depth image of a scene. For example, in time-of-flight analysis, the IR light component 425 of the capture device 20 may emit an infrared light onto the scene and may then use sensors (in some embodiments, including sensors not shown) to detect the backscattered light from the surface of one or more targets and objects in the scene using, for example, the 3-D camera 426 and/or the RGB camera 428. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, capture device 20 may use a structured light to capture depth information. In such an analysis, patterned light (i.e., light displayed as a known pattern such as a grid pattern, a stripe pattern, or different pattern) may be projected onto the scene via, for example, the IR light component 425. Upon striking the surface of one or more targets or objects in the scene, the pattern may become deformed in response. Such a deformation of the pattern may be captured by, for example, the 3-D camera 426 and/or the RGB camera 428 (and/or other sensor) and may then be analyzed to determine a physical distance from the capture device to a particular location on the targets or objects. In some implementations, the IR light component 425 is displaced from the cameras 426 and 428 so triangulation can be used to determined distance from cameras 426 and 428. In some implementations, the capture device 20 will include a dedicated IR sensor to sense the IR light, or a sensor with an IR filter.

According to another embodiment, one or more capture devices 20 may include two or more physically separated cameras that may view a scene from different angles to obtain visual stereo data that may be resolved to generate depth information. Other types of depth image sensors can also be used to create a depth image.

The capture device 20 may further include a microphone 430, which includes a transducer or sensor that may receive and convert sound into an electrical signal. Microphone 430 may be used to receive audio signals that may also be provided to hub computing system 12.

In an example embodiment, the capture device 20 may further include a processor 432 that may be in communication with the image camera component 423. Processor 432 may include a standardized processor, a specialized processor, a microprocessor, or the like that may execute instructions including, for example, instructions for receiving a depth image, generating the appropriate data format (e.g., frame) and transmitting the data to hub computing system 12.

Capture device 20 may further include a memory 434 that may store the instructions that are executed by processor 432, images or frames of images captured by the 3-D camera and/or RGB camera, or any other suitable information, images, or the like. According to an example embodiment, memory 434 may include random access memory (RAM), read only memory (ROM), cache, flash memory, a hard disk, or any other suitable storage component. As shown in FIG. 6, in one embodiment, memory 434 may be a separate component in communication with the image camera component 423 and processor 432. According to another embodiment, the memory 434 may be integrated into processor 432 and/or the image camera component 423.

Capture device 20 is in communication with hub computing system 12 via a communication link 436. The communication link 436 may be a wired connection including, for example, a USB connection, a Firewire connection, an Ethernet cable connection, or the like and/or a wireless connection such as a wireless 802.11b, g, a, or n connection. According to one embodiment, hub computing system 12 may provide a clock to capture device 20 that may be used to determine when to capture, for example, a scene via the communication link 436. Additionally, the capture device 20 provides the depth information and visual (e.g., RGB) images captured by, for example, the 3-D camera 426 and/or the RGB camera 428 to hub computing system 12 via the communication link 436. In one embodiment, the depth images and visual images are transmitted at 30 frames per second; however, other frame rates can be used. Hub computing system 12 may then create and use a model, depth information, and captured images to, for example, control an application such as a game or word processor and/or animate an avatar or on-screen character.

Hub computing system 12 includes a skeletal tracking module 450. Module 450 uses the depth images obtained in each frame from capture device 20, and possibly from cameras on the one or more head mounted display devices 2, to develop a representative model of each user 18a, 18b, 18c (or others) within the FOV of capture device 20 as each user moves around in the scene. This representative model may be a skeletal model described below. Hub computing system 12 may further include a scene mapping module 452. Scene mapping module 452 uses depth and possibly RGB image data obtained from capture device 20, and possibly from cameras on the one or more head mounted display devices 2, to develop a map or model of the scene in which the users 18a, 18b, 18c exist. The scene map may further include the positions of the users obtained from the skeletal tracking module 450. The hub computing system may further include a gesture recognition engine 454 for receiving skeletal model data for one or more users in the scene and determining whether the user is performing a predefined gesture or application-control movement affecting an application running on hub computing system 12.

The skeletal tracking module 450 and scene mapping module 452 are explained in greater detail below. More information about gesture recognition engine 454 can be found in U.S. patent application Ser. No. 12/422,661, entitled “Gesture Recognizer System Architecture,” filed on Apr. 13, 2009, incorporated herein by reference in its entirety. Additional information about recognizing gestures can also be found in U.S. patent application Ser. No. 12/391,150, entitled “Standard Gestures,” filed on Feb. 23, 2009; and U.S. patent application Ser. No. 12/474,655, entitled “Gesture Tool” filed on May 29, 2009, both of which are incorporated herein by reference in their entirety.

Capture device 20 provides RGB images (or visual images in other formats or color spaces) and depth images to hub computing system 12. The depth image may be a plurality of observed pixels where each observed pixel has an observed depth value. For example, the depth image may include a two-dimensional (2-D) pixel area of the captured scene where each pixel in the 2-D pixel area may have a depth value such as the distance of an object in the captured scene from the capture device. Hub computing system 12 will use the RGB images and depth images to develop a skeletal model of a user and to track a user's or other object's movements. There are many methods that can be used to model and track the skeleton of a person with depth images. One suitable example of tracking a skeleton using depth image is provided in U.S. patent application Ser. No. 12/603,437, entitled “Pose Tracking Pipeline” filed on Oct. 21, 2009, (hereinafter referred to as the '437 Application), incorporated herein by reference in its entirety.

The process of the '437 Application includes acquiring a depth image, down sampling the data, removing and/or smoothing high variance noisy data, identifying and removing the background, and assigning each of the foreground pixels to different parts of the body. Based on those steps, the system will fit a model to the data and create a skeleton. The skeleton will include a set of joints and connections between the joints. Other methods for user modeling and tracking can also be used. Suitable tracking technologies are also disclosed in the following four U.S. patent applications, all of which are incorporated herein by reference in their entirety: U.S. patent application Ser. No. 12/475,308, entitled “Device for Identifying and Tracking Multiple Humans Over Time,” filed on May 29, 2009; U.S. patent application Ser. No. 12/696,282, entitled “Visual Based Identity Tracking,” filed on Jan. 29, 2010; U.S. patent application Ser. No. 12/641,788, entitled “Motion Detection Using Depth Images,” filed on Dec. 18, 2009; and U.S. patent application Ser. No. 12/575,388, entitled “Human Tracking System,” filed on Oct. 7, 2009.

The above-described hub computing system 12, together with the head mounted display device 2 and processing unit 4, are able to insert a virtual three-dimensional object into the field of view of one or more users so that the virtual three-dimensional object augments and/or replaces the view of the real world. In one embodiment, head mounted display device 2, processing unit 4 and hub computing system 12 work together as each of the devices includes a subset of sensors that are used to obtain the data needed to determine where, when and how to insert the virtual three-dimensional object. In one embodiment, the calculations that determine where, when and how to insert a virtual three-dimensional object are performed by the hub computing system 12 and processing unit 4 working in tandem with each other. However, in further embodiments, all calculations may be performed by the hub computing system 12 working alone or the processing unit(s) 4 working alone. In other embodiments, at least some of the calculations can be performed by a head mounted display device 2.

In one example embodiment, hub computing system 12 and processing units 4 work together to create the scene map or model of the environment that the one or more users are in and track various moving objects in that environment. In addition, hub computing system 12 and/or processing unit 4 track the FOV of a head mounted display device 2 worn by a user 18a, 18b, 18c by tracking the position and orientation of the head mounted display device 2. Sensor information obtained by head mounted display device 2 is transmitted to processing unit 4. In one example, that information is transmitted to the hub computing system 12 which updates the scene model and transmits it back to the processing unit. The processing unit 4 then uses additional sensor information it receives from head mounted display device 2 to refine the field of view of the user and provide instructions to head mounted display device 2 on where, when and how to insert the virtual three-dimensional object. Based on sensor information from cameras in the capture device 20 and head mounted display device(s) 2, the scene model and the tracking information may be periodically updated between hub computing system 12 and processing unit 4 in a closed loop feedback system as explained below.

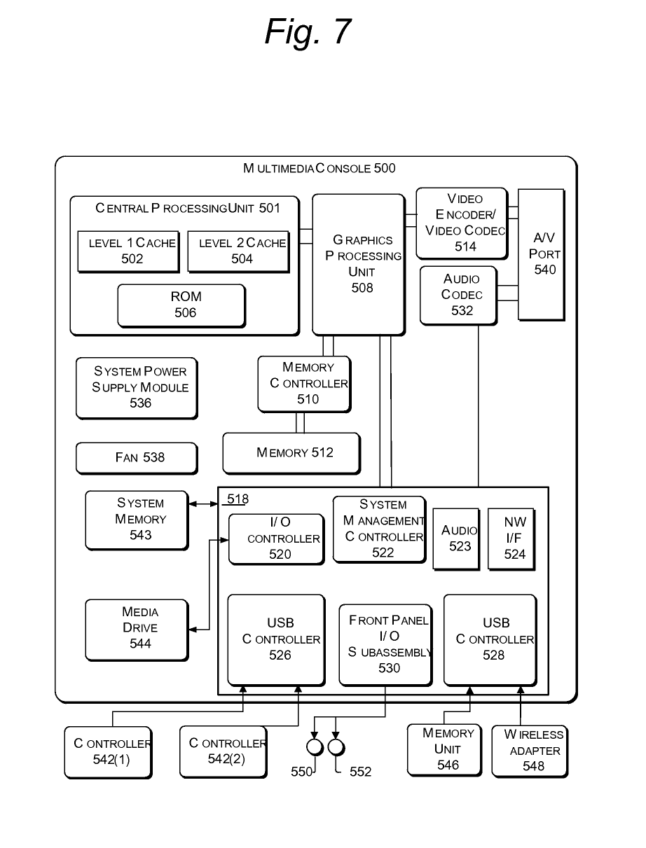

FIG. 7 illustrates an example embodiment of a computing system that may be used to implement hub computing system 12. As shown in FIG. 7, the multimedia console 500 has a central processing unit (CPU) 501 having a level 1 cache 502, a level 2 cache 504, and a flash ROM (Read Only Memory) 506. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM (Random Access Memory).

The multimedia console 500 includes an I/O controller 520, a system management controller 522, an audio processing unit 523, a network interface controller 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548, and an external memory device 546 (e.g., flash memory, external CD/DVD ROM drive, removable media, etc.). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. The media drive 544 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 500. A system power supply module 536 provides power to the components of the multimedia console 500. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community. Additionally, multimedia console 500 can communicate with processing unit 4 via wireless adaptor 548.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

After multimedia console 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application uses audio, audio processing is scheduled asynchronously to the gaming application due to time sensitivity. A multimedia console application manager (described below) controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 20 may define additional input devices for the console 500 via USB controller 526 or other interface. In other embodiments, hub computing system 12 can be implemented using other hardware architectures. No one hardware architecture is required.

Each of the head mounted display devices 2 and processing units 4 (collectively referred to at times as the mobile display device) shown in FIG. 1 are in communication with one hub computing system 12 (also referred to as the hub 12). There may be one, two or more than three mobile display devices in communication with the hub 12 in further embodiments. Each of the mobile display devices may communicate with the hub using wireless communication, as described above. In such an embodiment, it is contemplated that much of the information that is useful to all of the mobile display devices will be computed and stored at the hub and transmitted to each of the mobile display devices. For example, the hub will generate the model of the environment and provide that model to all of the mobile display devices in communication with the hub. Additionally, the hub can track the location and orientation of the mobile display devices and of the moving objects in the room, and then transfer that information to each of the mobile display devices.

In another embodiment, a system could include multiple hubs 12, with each hub including one or more mobile display devices. The hubs can communicate with each other directly or via the Internet (or other networks). Such an embodiment is disclosed in U.S. patent application Ser. No. 12/905,952, entitled “Fusing Virtual Content Into Real Content,” to Flaks et al., filed Oct. 15, 2010, which application is incorporated by reference herein in its entirety.

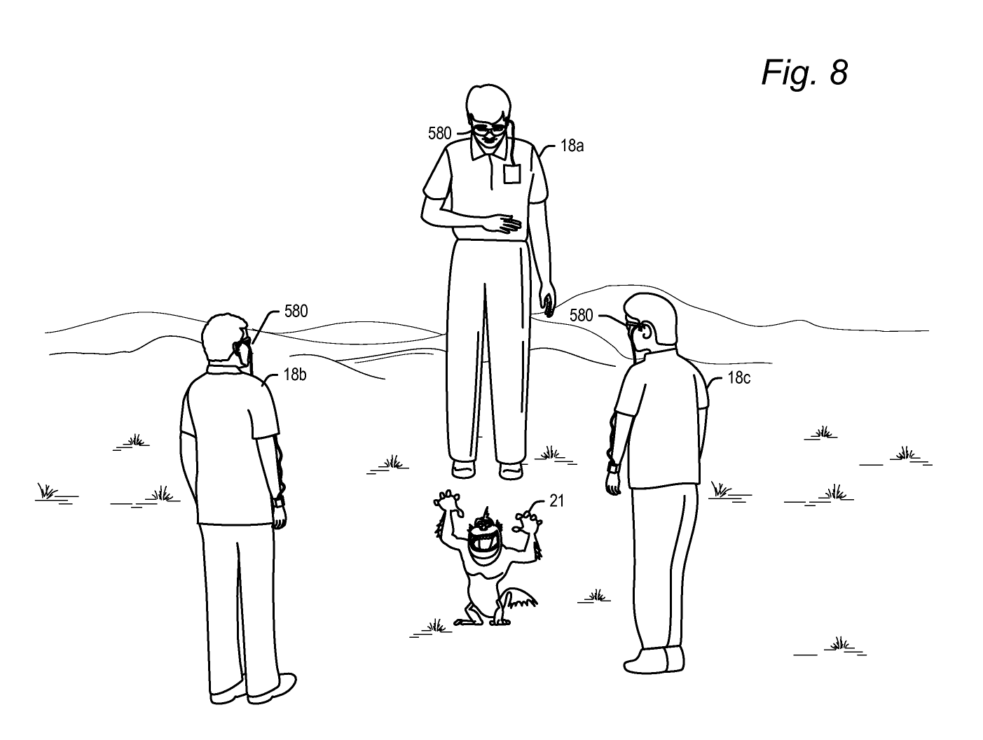

Moreover, in further embodiments, the hub 12 may be omitted altogether. Such an embodiment is shown for example in FIG. 8. This embodiment may include one, two or more than three mobile display devices 580 in further embodiments. One benefit of such an embodiment is that the mixed reality experience of the present system becomes completely mobile, and may be used in both indoor or outdoor settings.

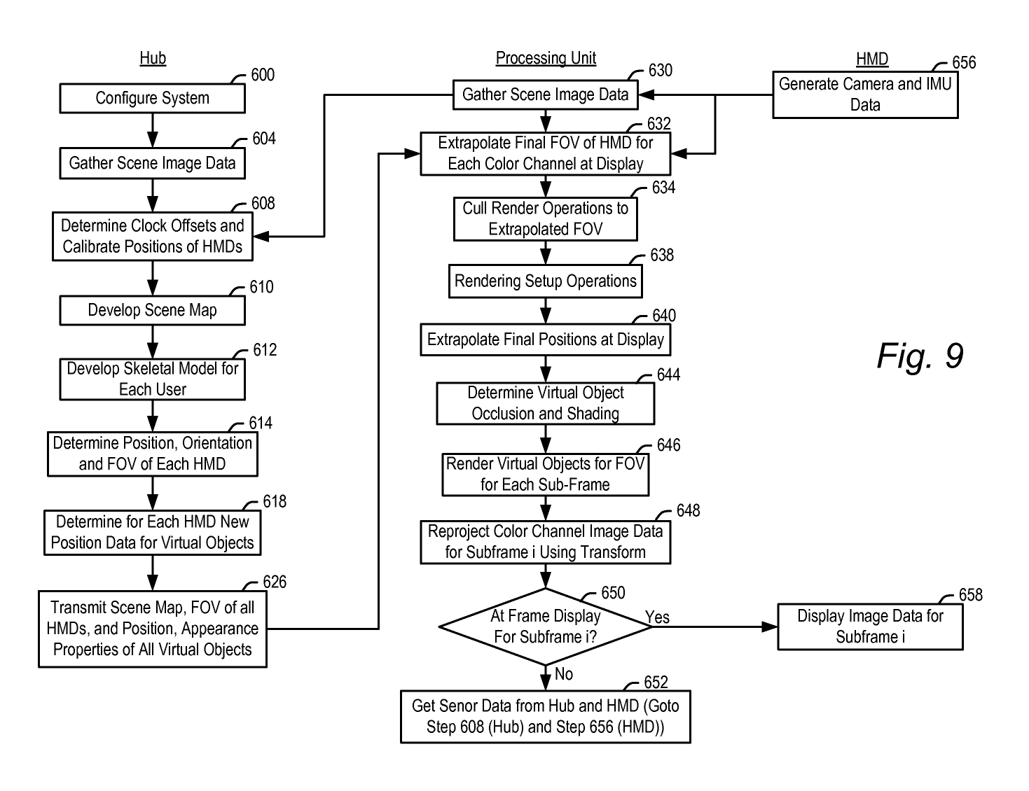

In the embodiment of FIG. 8, all functions performed by the hub 12 in the description that follows may alternatively be performed by one of the processing units 4, some of the processing units 4 working in tandem, or all of the processing units 4 working in tandem. In such an embodiment, the respective mobile display devices 580 perform all functions of system 10, including generating and updating state data, a scene map, each user's view of the scene map, all texture and rendering information, video and audio data, and other information used to perform the operations described herein. The embodiments described below with respect to the flowchart of FIG. 9 include a hub 12. However, in each such embodiment, one or more of the processing units 4 may alternatively perform all described functions of the hub 12.

FIG. 9 is high level flowchart of the operation and interactivity of the hub computing system 12, the processing unit 4 and head mounted display device 2 during a discrete time period such as the time it takes to generate, render and display a single frame of image data to each user. In embodiments, the display may be refreshed at a rate of 60 hertz, though it may be refreshed more often or less often in further embodiments. As explained in greater detail below, in embodiments, a single refreshed frame of image data is comprised of three sequential sub-frames of different color, for example green, red and blue. Each of these sub-frames is generated, rendered and displayed at a rate so that, all three together may comprise a single frame of image data. Thus, in an example where a single frame of image data is refreshed on the display at a rate of 60 hertz, each of three sub-frames may be generated at a rate of at least 180 hertz. In further examples, the sub-frames may be generated at a rate of 240 hertz or 320 hertz. Other frequencies are contemplated.

In general, the system generates a scene map having x, y, z coordinates of the environment and objects in the environment such as users, real world objects and virtual objects. The virtual object may be virtually placed in the environment for example by an application running on hub computing system 12. The system also tracks the FOV of each user. While all users may possibly be viewing the same aspects of the scene, they are viewing them from different perspectives. Thus, the system generates each person's field of view of the scene to adjust for parallax and occlusion of virtual or real world objects, which may again be different for each user.

For a given frame of image data, a user's view may include one or more real and/or virtual objects. As a user turns his head, for example left to right or up and down, the relative position of real world objects in the user's field of view inherently moves within the user's field of view. However, the display of virtual objects to a user as the user moves his head is a more difficult problem. A virtual object may appear in the user's FOV that is stationary in the scene. This type of virtual object is referred to herein as a “scene-locked virtual object.” In an example where a scene-locked virtual object is in the user's FOV, if the user moves his head left to move the FOV left, the display of the virtual object needs to be shifted to the right by an amount of the user's FOV shift, so that the net effect is that the scene-locked virtual object remains stationary within the FOV.

A virtual object may alternatively move with the user's head (such as for example virtually-displayed cross-hairs in the user's view. This type of virtual object is referred to herein as a “head-locked virtual object.” In an example where a head-locked virtual object is in the user's FOV, if the user moves his head, the display of the head-locked virtual object does not change. A virtual object may further be a dynamic virtual object which is moving relative to the scene and the user's head. A system for displaying such virtual objects without color break-up is explained below with respect to the flowchart of FIGS. 9-16 below. In particular, scene-locked and dynamic virtual objects may be displayed using extrapolation techniques to predict positions in a user's FOV of the scene-locked and dynamic objects into the future to a time when these objects are to be displayed.

The system for presenting mixed reality to one or more users 18a, 18b and 18c may be configured in step 600. For example, a user 18a, 18b, 18c or other user or operator of the system may specify the virtual objects that are to be presented, as well as how, when and where they are to be presented. In an alternative embodiment, an application running on hub 12 and/or processing unit 4 can configure the system as to the virtual objects that are to be presented.

In steps 604 and 630, hub 12 and processing unit 4 gather data from the scene. For the hub 12, this may be image and audio data sensed by the depth camera 426, RGB camera 428 and microphone 430 of capture device 20. For the processing unit 4, this may be image data sensed in step 652 by the head mounted display device 2, and in particular, by the cameras 112, the eye tracking assemblies 134 and the IMU 132. The data gathered by the head mounted display device 2 is sent to the processing unit 4 in step 656. The processing unit 4 processes this data, as well as sending it to the hub 12 in step 630.

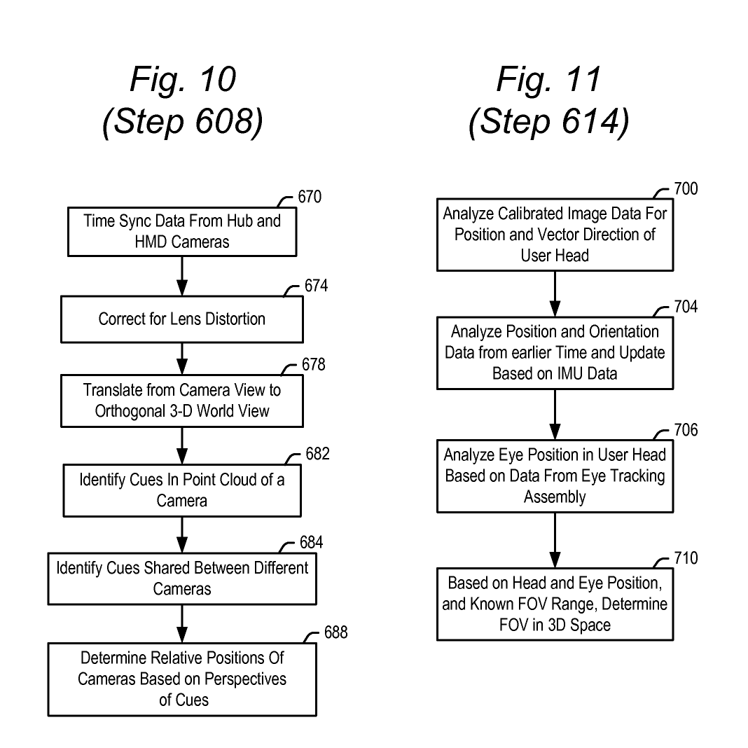

In step 608, the hub 12 performs various setup operations that allow the hub 12 to coordinate the image data of its capture device 20 and the one or more processing units 4. In particular, even if the position of the capture device 20 is known with respect to a scene (which it may not be), the cameras on the head mounted display devices 2 are moving around in the scene. Therefore, in embodiments, the positions and time capture of each of the imaging cameras need to be calibrated to the scene, each other and the hub 12. Further details of step 608 are described below in the flowchart of FIG. 10.

One operation of step 608 includes determining clock offsets of the various imaging devices in the system 10 in a step 670. In particular, in order to coordinate the image data from each of the cameras in the system, it may be ensured that the image data being coordinated is from the same time. Details relating to determining clock offsets and synching of image data are disclosed in U.S. patent application Ser. No. 12/772,802, entitled “Heterogeneous Image Sensor Synchronization,” filed May 3, 2010, and U.S. patent application Ser. No. 12/792,961, entitled “Synthesis Of Information From Multiple Audiovisual Sources,” filed Jun. 3, 2010, which applications are incorporated herein by reference in their entirety. In general, the image data from capture device 20 and the image data coming in from the one or more processing units 4 is time stamped off a single master clock in hub 12. Using the time stamps for all such data for a given frame, as well as the known resolution for each of the cameras, the hub 12 determines the time offsets for each of the imaging cameras in the system. From this, the hub 12 may determine the differences between, and an adjustment to, the images received from each camera.

The hub 12 may select a reference time stamp from one of the cameras' received frame. The hub 12 may then add time to or subtract time from the received image data from all other cameras to synch to the reference time stamp. It is appreciated that a variety of other operations may be used for determining time offsets and/or synchronizing the different cameras together for the calibration process. The determination of time offsets may be performed once, upon initial receipt of image data from all the cameras. Alternatively, it may be performed periodically, such as for example each frame or some number of frames.

Step 608 further includes the operation of calibrating the positions of all cameras with respect to each other in the x, y, z Cartesian space of the scene. Once this information is known, the hub 12 and/or the one or more processing units 4 is able to form a scene map or model to identify the geometry of the scene and the geometry and positions of objects (including users) within the scene. In calibrating the image data of all cameras to each other, depth and/or RGB data may be used. Technology for calibrating camera views using RGB information alone is described for example in U.S. Patent Publication No. 2007/0110338, entitled “Navigating Images Using Image Based Geometric Alignment and Object Based Controls,” published May 17, 2007, which publication is incorporated herein by reference in its entirety.

The imaging cameras in system 10 may each have some lens distortion which needs to be corrected for in order to calibrate the images from different cameras Once all image data from the various cameras in the system is received in steps 604 and 630, the image data may be adjusted to account for lens distortion for the various cameras in step 674. The distortion of a given camera (depth or RGB) may be a known property provided by the camera manufacturer. If not, algorithms are known for calculating a camera's distortion, including for example imaging an object of known dimensions such as a checker board pattern at different locations within a camera's field of view. The deviations in the camera view coordinates of points in that image will be the result of camera lens distortion. Once the degree of lens distortion is known, distortion may be corrected by known inverse matrix transformations that result in a uniform camera view map of points in a point cloud for a given camera.

The hub 12 may next translate the distortion-corrected image data points captured by each camera from the camera view to an orthogonal 3-D world view in step 678. This orthogonal 3-D world view is a point cloud map of all image data captured by capture device 20 and the head mounted display device cameras in an orthogonal x, y, z Cartesian coordinate system. The matrix transformation equations for translating camera view to an orthogonal 3-D world view are known. See, for example, David H. Eberly, “3d Game Engine Design: A Practical Approach To Real-Time Computer Graphics,” Morgan Kaufman Publishers (2000), which publication is incorporated herein by reference in its entirety. See also, U.S. patent application Ser. No. 12/792,961, previously incorporated by reference.

Each camera in system 10 may construct an orthogonal 3-D world view in step 678. The x, y, z world coordinates of data points from a given camera are still from the perspective of that camera at the conclusion of step 678, and not yet correlated to the x, y, z world coordinates of data points from other cameras in the system 10. The next step is to translate the various orthogonal 3-D world views of the different cameras into a single overall 3-D world view shared by all cameras in system 10.

To accomplish this, embodiments of the hub 12 may next look for key-point discontinuities, or cues, in the point clouds of the world views of the respective cameras in step 682. The hub 12 may then identify cues that are the same between different point clouds of different cameras in step 684. Once the hub 12 is able to determine that two world views of two different cameras include the same cues, the hub 12 is able to determine the position, orientation and focal length of the two cameras with respect to each other and the cues in step 688. In embodiments, not all cameras in system 10 will share the same common cues. However, as long as a first and second camera have shared cues, and at least one of those cameras has a shared view with a third camera, the hub 12 is able to determine the positions, orientations and focal lengths of the first, second and third cameras relative to each other and a single, overall 3-D world view. The same is true for additional cameras in the system.

Various known algorithms exist for identifying cues from an image point cloud. Such algorithms are set forth for example in Mikolajczyk, K., and Schmid, C., “A Performance Evaluation of Local Descriptors,” IEEE Transactions on Pattern Analysis & Machine Intelligence, 27, 10, 1615-1630. (2005), which paper is incorporated by reference herein in its entirety. A further method of detecting cues with image data is the Scale-Invariant Feature Transform (SIFT) algorithm. The SIFT algorithm is described for example in U.S. Pat. No. 6,711,293, entitled, “Method and Apparatus for Identifying Scale Invariant Features in an Image and Use of Same for Locating an Object in an Image,” issued Mar. 23, 2004, which patent is incorporated by reference herein in its entirety. Another cue detector method is the Maximally Stable Extremal Regions (MSER) algorithm. The MSER algorithm is described for example in the paper by J. Matas, O. Chum, M. Urba, and T. Pajdla, “Robust Wide Baseline Stereo From Maximally Stable Extremal Regions,” Proc. of British Machine Vision Conference, pages 384-396 (2002), which paper is incorporated by reference herein in its entirety.

In step 684, cues which are shared between point clouds from two or more cameras are identified. Conceptually, where a first set of vectors exist between a first camera and a set of cues in the first camera's Cartesian coordinate system, and a second set of vectors exist between a second camera and that same set of cues in the second camera's Cartesian coordinate system, the two systems may be resolved with respect to each other into a single Cartesian coordinate system including both cameras. A number of known techniques exist for finding shared cues between point clouds from two or more cameras. Such techniques are shown for example in Arya, S., Mount, D. M., Netanyahu, N. S., Silverman, R., and Wu, A. Y., “An Optimal Algorithm For Approximate Nearest Neighbor Searching Fixed Dimensions,” Journal of the ACM 45, 6, 891-923 (1998), which paper is incorporated by reference herein in its entirety. Other techniques can be used instead of, or in addition to, the approximate nearest neighbor solution of Arya et al., incorporated above, including but not limited to hashing or context-sensitive hashing.

Where the point clouds from two different cameras share a large enough number of matched cues, a matrix correlating the two point clouds together may be estimated, for example by Random Sampling Consensus (RANSAC), or a variety of other estimation techniques. Matches that are outliers to the recovered fundamental matrix may then be removed. After finding a set of assumed, geometrically consistent matches between a pair of point clouds, the matches may be organized into a set of tracks for the respective point clouds, where a track is a set of mutually matching cues between point clouds. A first track in the set may contain a projection of each common cue in the first point cloud. A second track in the set may contain a projection of each common cue in the second point cloud. Using this information, the point clouds from different cameras may be resolved into a single point cloud in a single orthogonal 3-D real world view.

The positions and orientations of all cameras are calibrated with respect to this single point cloud and single orthogonal 3-D real world view. In order to resolve the various point clouds together, the projections of the cues in the set of tracks for two point clouds are analyzed. From these projections, the hub 12 can determine the perspective of a first camera with respect to the cues, and can also determine the perspective of a second camera with respect to the cues. From that, the hub 12 can resolve the point clouds into a best estimate of a single point cloud and single orthogonal 3-D real world view containing the cues and other data points from both point clouds.

This process is repeated for any other cameras, until the single orthogonal 3-D real world view includes all cameras. Once this is done, the hub 12 can determine the relative positions and orientations of the cameras relative to the single orthogonal 3-D real world view and each other. The hub 12 can further determine the focal length of each camera with respect to the single orthogonal 3-D real world view.

Referring again to FIG. 9, once the system is calibrated in step 608, a scene map may be developed in step 610 identifying the geometry of the scene as well as the geometry and positions of objects within the scene. In embodiments, the scene map generated in a given frame may include the x, y and z positions of all users, real world objects and virtual objects in the scene. All of this information is obtained during the image data gathering steps 604, 656 and is calibrated together in step 608.

At least the capture device 20 includes a depth camera for determining the depth of the scene (to the extent it may be bounded by walls, etc.) as well as the depth position of objects within the scene. As explained below, the scene map is used in positioning virtual objects within the scene, as well as displaying virtual three-dimensional objects with the proper occlusion (a virtual three-dimensional object may be occluded or a virtual three-dimensional object may occlude a real world object or another virtual three-dimensional object). The system 10 may include multiple depth image cameras to obtain all of the depth images from a scene, or a single depth image camera, such as for example depth image camera 426 of capture device 20 may be sufficient to capture all depth image from a scene. An analogous method for determining a scene map within an unknown environment is known as simultaneous localization and mapping (SLAM). One example of SLAM is disclosed in U.S. Pat. No. 7,774,158, entitled “Systems and Methods for Landmark Generation for Visual Simultaneous Localization and Mapping,” issued Aug. 10, 2010, which patent is incorporated herein by reference in its entirety.

In step 612, the system will detect and track moving objects such as humans moving in the room, and update the scene map based on the positions of moving objects. This includes the use of skeletal models of the users within the scene as described above. In step 614, the hub determines the x, y and z position, the orientation and the FOV of each head mounted display device 2 for all users within the system 10. Further details of step 616 are described below with respect to the flowchart of FIG. 11. The steps of FIG. 11 are described below with respect to a single user. However, the steps of FIG. 11 would be carried out for each user within the scene.

In step 700, the calibrated image data for the scene is analyzed at the hub to determine both the user head position and a face unit vector looking straight out from a user's face. The head position is identified in the skeletal model. The face unit vector may be determined by defining a plane of the user's face from the skeletal model, and taking a vector perpendicular to that plane. This plane may be identified by determining a position of a user's eyes, nose, mouth, ears or other facial features. The face unit vector may be used to define the user's head orientation and may be considered the center of the FOV for the user. The face unit vector may also or alternatively be identified from the camera image data returned from the cameras 112 on head mounted display device 2. In particular, based on what the cameras 112 on head mounted display device 2 see, the associated processor 104 and/or hub 12 is able to determine the face unit vector representing a user's head orientation.

In step 704, the position and orientation of a user's head may also or alternatively be determined from analysis of the position and orientation of the user's head from an earlier time (either earlier in the frame or from a prior frame), and then using the inertial information from the IMU 132 to update the position and orientation of a user's head. Information from the IMU 132 may provide accurate kinematic data for a user's head, but the IMU typically does not provide absolute position information regarding a user's head. This absolute position information, also referred to as “ground truth,” may be provided from the image data obtained from capture device 20, the cameras on the head mounted display device 2 for the subject user and/or from the head mounted display device(s) 2 of other users.

In embodiments, the position and orientation of a user's head may be determined by steps 700 and 704 acting in tandem. In further embodiments, one or the other of steps 700 and 704 may be used to determine head position and orientation of a user's head.

It may happen that a user is not looking straight ahead. Therefore, in addition to identifying user head position and orientation, the hub may further consider the position of the user's eyes in his head. This information may be provided by the eye tracking assembly 134 described above. The eye tracking assembly is able to identify a position of the user's eyes, which can be represented as an eye unit vector showing the left, right, up and/or down deviation from a position where the user's eyes are centered and looking straight ahead (i.e., the face unit vector). A face unit vector may be adjusted to the eye unit vector to define where the user is looking.

In step 710, the FOV of the user may next be determined The range of view of a user of a head mounted display device 2 may be predefined based on the up, down, left and right peripheral vision of a hypothetical user. In order to ensure that the FOV calculated for a given user includes objects that a particular user may be able to see at the extents of the FOV, this hypothetical user may be taken as one having a maximum possible peripheral vision. Some predetermined extra FOV may be added to this to ensure that enough data is captured for a given user in embodiments.

The FOV for the user at a given instant may then be calculated by taking the range of view and centering it around the face unit vector, adjusted by any deviation of the eye unit vector. In addition to defining what a user is looking at in a given instant, this determination of a user's field of view is also useful for determining what a user cannot see. As explained below, limiting processing of virtual objects to those areas that a particular user can see improves processing speed and reduces latency.

In the embodiment described above, the hub 12 calculates the FOV of each user in the scene. In further embodiments, the processing unit 4 for a user may share in this task. For example, once user head position and eye orientation are estimated, this information may be sent to the processing unit which can update the position, orientation, etc. based on more recent data as to head position (from IMU 132) and eye position (from eye-tracking assembly 134).

Returning now to FIG. 9, an application running on hub 12 may have placed virtual objects in the scene. In step 618, the hub may use the scene map and any application-defined movement of the virtual objects, to determine the x, y and z positions of all such virtual objects at the current time. Alternatively, this information may be generated by one or more of the processing units 4 and sent to the hub 12 in step 618. As noted above, virtual objects may be scene-locked, head-locked, or moving within the scene independently of the user's head. The new position of the virtual object(s) in the user's FOV may be determined accordingly. As a further possibility, a virtual object may be registered to a real world object, such as a user. For example, a virtual object may be provided over or around a user to augment or alter the appearance of a user. In such embodiments, the position of the virtual object would change based on the possibly changing position of the user to which the virtual object is registered.

Once the above steps 600 through 618 have been performed, the hub 12 may transmit the determined information to the one or more processing units 4 in step 626. The information transmitted in step 626 includes transmission of the scene map to the processing units 4 of all users. The transmitted information may further include transmission of the determined FOV of each head mounted display device 2 to the processing units 4 of the respective head mounted display devices 2. The transmitted information may further include transmission of virtual object characteristics, including the determined position, orientation, shape, appearance and occlusion properties (i.e., whether the virtual object blocks or is blocked by another object from a particular user's view).

The processing steps 600 through 626 are described above by way of example only. It is understood that one or more of these steps may be omitted in further embodiments, the steps may be performed in differing order, or additional steps may be added. The processing steps 604 through 618 may be computationally expensive but the powerful hub 12 may perform these steps several times in a 60 Hertz frame. In further embodiments, one or more of the steps 604 through 618 may alternatively or additionally be performed by one or more of the one or more processing units 4. Moreover, while FIG. 9 shows determination of various parameters, and then transmission of these parameters all at once in step 626, it is understood that determined parameters may be sent to the processing unit(s) 4 asynchronously as soon as they are determined.

The operation of the processing unit 4 and head mounted display device 2 will now be explained with reference to steps 630 through 658. As noted above, in embodiments, the head mounted display device 2 may use a color sequential display generating sub-frames of color image data of the user's FOV based on user pose including head and eye position as described above. The processing steps to render and display these sub-frames of color image data may be performed differently in different embodiments. However, in one example, each sub-frame of image data may be rendered at the same time, e.g., time t₁, for display via micro display 120 at different times, e.g., times t₂, t₃ and t₄.

As the times t₂, t₃ and t₄ are spaced a very short time apart, the display of the successive sub-frames of color image data may appear as a single cohesive color image to the user. However, as discussed in the Background section, where a user is moving, this time difference may result in color break-up of the respective sub-frames of color image data. As such, the present technology extrapolates positions of scene-locked and dynamic virtual objects to times when sub-frames of color image data for the virtual objects are to be displayed to the user.

Thus, for the first sub-frame of color image data (also referred to herein as a “color channel”), processing unit 4 extrapolates data to predict the final position of objects in a scene, and the associated user's view of those objects, for the first color channel at a time t₂ in the future when the first color channel is to be displayed to a user. Similarly, for the second color channel, processing unit 4 extrapolates data to predict the final position of objects in a scene, and the associated user's view of those objects, for the second color channel at a time t₃ in the future when the second color channel is to be displayed to a user. And for the third color channel, processing unit 4 extrapolates data received to predict the final position of objects in a scene, and the associated user's view of those objects, for the third color channel at a time t₄ in the future when the third color channel is to be displayed to a user. In so doing, the present technology effectively negates latency within the system and provides proper alignment and fusing of each color channel when displayed over each other at times t₂, t₃ and t₄.

Additionally, the extrapolated data for the first, second and third color image channels may be generated for both the left eye and the right eye, independently of each other. While not separately described, it is understood that the following description may apply to generation and display of color image data for both the left and right eyes.

In step 632, the processing unit may make an initial determination of the final FOV of the head mounted display device 2 at the time the color channels are displayed. Predictions tend to be more accurate when the time between the prediction and the display of the images to the user is short. As such, a further refinement of the prediction may be performed as explained below with respect to step 648 just before the display of the image to reproject the rendered image using a translational or homography reprojection.

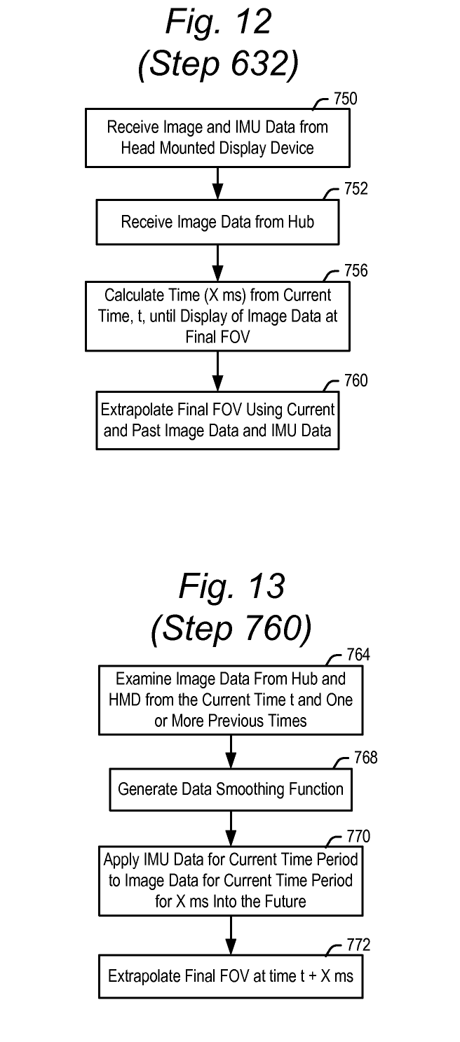

As noted above, in an initial step 656, the head mounted display device 2 generates image and IMU data, which is sent to the hub 12 via the processing unit 4 in step 630. While the hub 12 is processing the image data, the processing unit 4 is also processing the image data, as well as performing steps in preparation for rendering an image. In step 632, the processing unit 4 may use state information from the past and/or present to extrapolate a state estimate of a future time when the head mounted display unit 2 presents a rendered frame of image data to the user of the head mounted display device 2. In particular, the processing unit in step 632 determines a prediction of the final FOV of the head mounted display device 2 at some time in the future when the image is to be displayed to the head mounted display device 2. Further details of one example of step 632 are explained below with reference to the flowchart of FIG. 12.

In step 750, the processing unit 4 receives image and IMU data from the head mounted display device 2, and in step 752, the processing unit 4 receives processed image data including the scene map, the FOV of the head mounted display device 2 and occlusion data.

In step 756, the processing unit 4 calculates a time, X milliseconds (ms), from the current time, t, until the image is displayed through head mounted display device 2. In general, X may be up to 250 ms, though it may be more or less than that in further embodiments. Moreover, while embodiments are described below in terms of predicting X milliseconds out in to the future, it is understood that X may be described in units of time measurement larger or smaller than milliseconds. As the processing unit 4 cycles through its operations for subsequent color channel sub-frames as explained below and gets closer to the time when an image is to be displayed for a given frame, the time period X gets smaller.

In step 760, the processing unit 4 extrapolates the final FOV of the head mounted display device 2 at the time when the image is to be displayed on the head mounted display device 2. As noted above, the different color channels may be displayed at different times. Thus, in one example, steps 756 and 760 may extrapolate final FOV at a single time, for example at time t₂ for all color channels. In a further embodiment, steps 756 and 760 may extrapolate the final FOV for the respective color channels at different times, t₂, t₃ and t₄. Depending on the timing of the processing steps between the hub 12 and the processing unit 4, the processing unit 4 may not have received the data from the hub the first time the processing unit 4 performs step 632. In this instance, the processing unit may still be able to make these determinations where the cameras 112 in the head mounted display device 2 include a depth camera. If not, then the processing unit 4 may perform step 760 upon receipt of information from the hub 12.

Step 760 of extrapolating the final FOV is based on the fact that, over small time periods such as a few frames of data, movements tend to be generally smooth and steady. As such, by looking at data from the current time t, and data from previous times, it is possible to extrapolate into the future to predict the user's final view position when the frame image data is to be displayed. Using this prediction of the final FOV, the final FOV may be displayed to the user at t+X ms without any latency. As noted above, the extrapolated time X ms may be a single time used for all color channels, or each color channel may have a different extrapolated time X ms, based on when it is to be displayed.

Further details of step 760 are provided in the flowchart of FIG. 13. In step 764, image data received from the hub 12 and/or the head mounted display device 2 relating to the FOV is examined In step 768, a smoothing function may be applied to the examined data which captures a pattern in the head position data while ignoring noise or anomalous points of data. The number of time periods examined may be two or more distinct time periods.

In addition to or instead of steps 764 and 768, the processing unit 4 may perform a step 770 of using the current FOV data as ground truth for the head mounted display device 2, as indicated by the head mounted display device 2 and/or hub 12. The processing unit 4 may then apply the data from the IMU unit 132 for the current time period to determine the final field of view X ms into the future. The IMU unit 132 may provide kinematic measurements such as velocity, acceleration and jerk for movement of the head mounted display device 2 in six degrees of freedom: translation along three axes and rotation about three axes. Using these measurements for a current time period, it is a straightforward extrapolation to determine a net change from the current FOV position to a final field of view X ms into the future. Using the data from steps 764, 768 and 770, the final FOV at the time(s) of display may be extrapolated in step 772.

In addition to predicting a final FOV of the head mounted display device 2 for one or more of the color channel sub-frames by extrapolating into the future, the processing unit 4 may also determine a confidence value in the prediction, referred to herein as instantaneous prediction error. It may happen that a user is moving his head too rapidly for the processing unit 4 to extrapolate the data within an acceptable accuracy level. Where the instantaneous prediction error is above some predetermined threshold level, mitigation techniques may be employed instead of relying on the extrapolated prediction as to final view position. Mitigation techniques include reducing or turning off the display of the virtual images. While not ideal, the situation is likely temporary and may be preferable to presenting an image mismatch between the color channels. Another mitigation technique is to fall back to the last data obtained having an acceptable instantaneous prediction error. Further mitigation techniques including blurring of the data (which may be a perfectly acceptable method of displaying virtual images for rapid head movements), and blending of one or more of the above-described mitigation techniques.

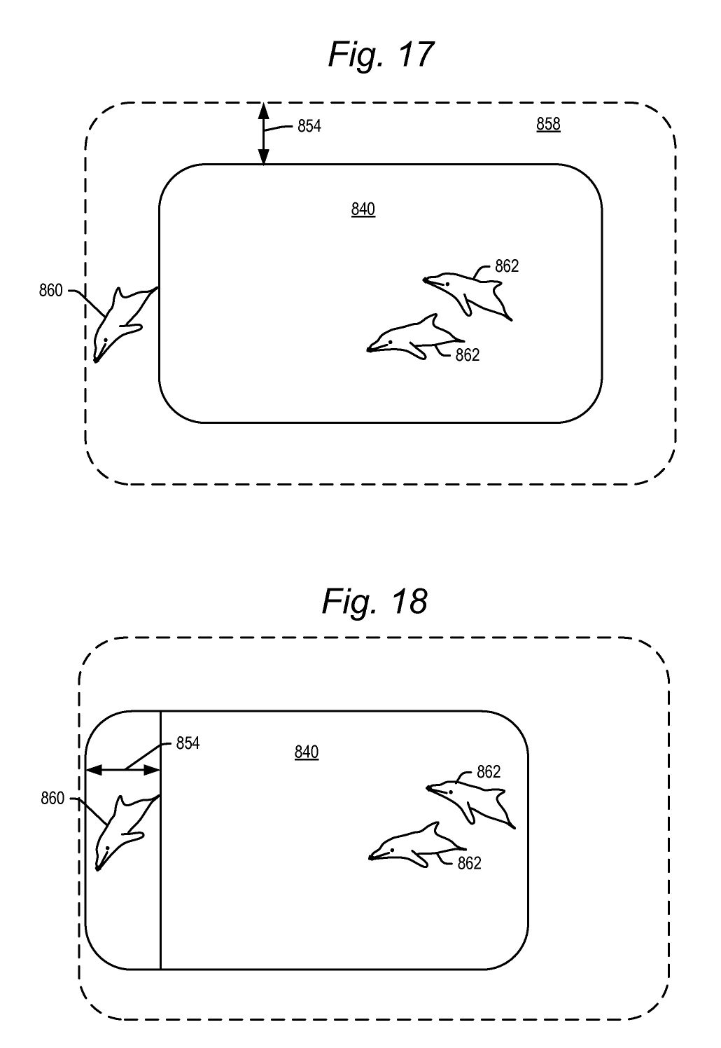

Referring again to the flowchart of FIG. 9, after extrapolating the final view in step 632 for the one or more color channel sub-frames, the processing unit 4 may next cull the rendering operations in step 634 so that just those virtual objects which could possibly appear within the final FOV of the head mounted display device 2 are rendered. The positions of other virtual objects may still be tracked, but they are not rendered. As explained below with respect to FIGS. 17 and 18, in an alternative embodiment, step 634 may include culling the rendering operations to the possible FOV, plus an additional border around the periphery of the FOV. This will allow image adjustment at a high frame rate without re-rendering of the data across the whole FOV. It is also conceivable that, in further embodiments, step 634 may be skipped altogether and the whole image is rendered.

The processing unit 4 may next perform a rendering setup step 638 for a determined color channel sub-frame, where setup rendering operations are performed using the extrapolated final FOV prediction determined in step 632. Step 638 performs setup rendering operations on the virtual three-dimensional objects to be rendered. In embodiments where the virtual object data is provided to the processing unit 4 from the hub 12, step 638 may be skipped until such time as the virtual object data is supplied to the processing unit 4 (for example, the first time through the processing unit steps).

Once virtual object data is received, the processing unit may perform rendering setup operations in step 638 for the virtual objects which may appear in the final FOV. The setup rendering operations in step 638 may include common rendering tasks associated with the virtual object(s) to be displayed in the final FOV. These rendering tasks may include for example, shadow map generation, lighting, and animation. In embodiments, the rendering setup step 638 may further include a compilation of likely draw information such as vertex buffers, textures and states for virtual objects to be displayed in the predicted final FOV.

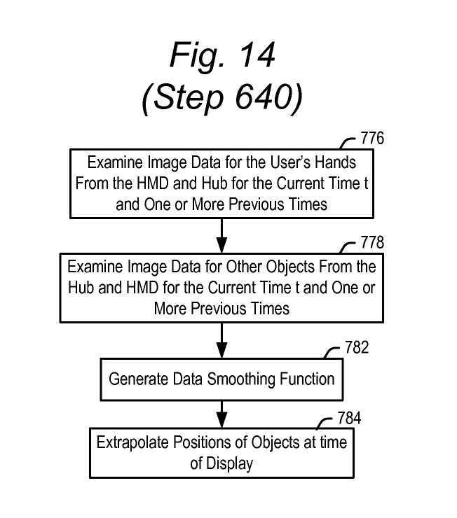

Step 632 determined a prediction of the FOV for the head mounted display device 2 at a time when a frame of image data is to be displayed on the head mounted display device. However, in addition to the FOV, virtual and real objects (such as the user's hands and other users) may be moving in the scene as well. Thus, in addition to extrapolating the final FOV position for each user at the time of display, the system may also extrapolate in step 640 the position for all objects (or all moving objects) in the scene at the time of display, both real and virtual. This information may be helpful in order to properly display the virtual and real objects, and display them with the proper occlusions. Further details of the step 640 are shown in the flowchart of FIG. 14.

In step 776, the processing unit 4 may examine the position data for the position of a user's hands in x, y, z space from the current time t and previous times. This hand position data may come from the head mounted display device 2 and, possibly, from the hub 12. In step 778, the processing unit may similarly examine the position data for other objects in the scene at the current time t and previous times. In embodiments, the examined objects may be all objects in the scene, or just those that are identified as moving objects, such as people. In further embodiments, the examined objects may be limited to those calculated to be within the final FOV of the user at the time of display. The number of time periods examined in steps 776 and 778 may be two or more distinct time periods.

In step 782, a smoothing function may be applied to the examined data in steps 776 and 778 while ignoring noise or anomalous points of data. Using steps 776, 778 and 782, the processing unit may extrapolate the positions of the user's hands and other objects in the scene at the time of display.

In one example, a user may be moving their hand in front of their eyes. By tracking this movement with data from the head mounted display device 2 and/or hub 12, the processing unit may predict the position of the user's hand when the image is to be displayed, and any virtual objects in the user's FOV that are occluded by the user's hand at that time are properly displayed. As a further example, a virtual object may be “tagged” to the outline of another user in the scene. By tracking the movement of this tagged user with data from the hub 12 and/or head mounted display device 2, the processing unit may predict the position of the tagged user when the image is to be displayed, and the associated virtual object may be properly displayed around the user's outline. Other examples are contemplated where the extrapolation of FOV data and object position data into the future allows virtual objects to be properly displayed in a user's FOV each frame without latency.

Referring again to FIG. 9, using the extrapolated positions of objects at the time of display, the processing unit 4 may next determine occlusions and shading in the user's predicted FOV in step 644. In particular, the screen map has x, y and z positions of all objects in the scene, including moving and non-moving objects and the virtual objects. Knowing the location of a user and their line of sight to objects in the FOV, the processing unit 4 may then determine whether a virtual object partially or fully occludes the user's view of a real world object. Additionally, the processing unit 4 may determine whether a real world object partially or fully occludes the user's view of a virtual object. Occlusions are user-specific. A virtual object may block or be blocked in the view of a first user, but not a second user. Accordingly, occlusion determinations may be performed in the processing unit 4 of each user. However, it is understood that occlusion determinations may additionally or alternatively be performed by the hub 12.

In step 646, using the predicted final FOV and predicted object positions and occlusions, the GPU 322 of processing unit 4 may next render an image for each sub-frame i to be displayed to the user. Portions of the rendering operations may have already been performed in the rendering setup step 638 and periodically updated.

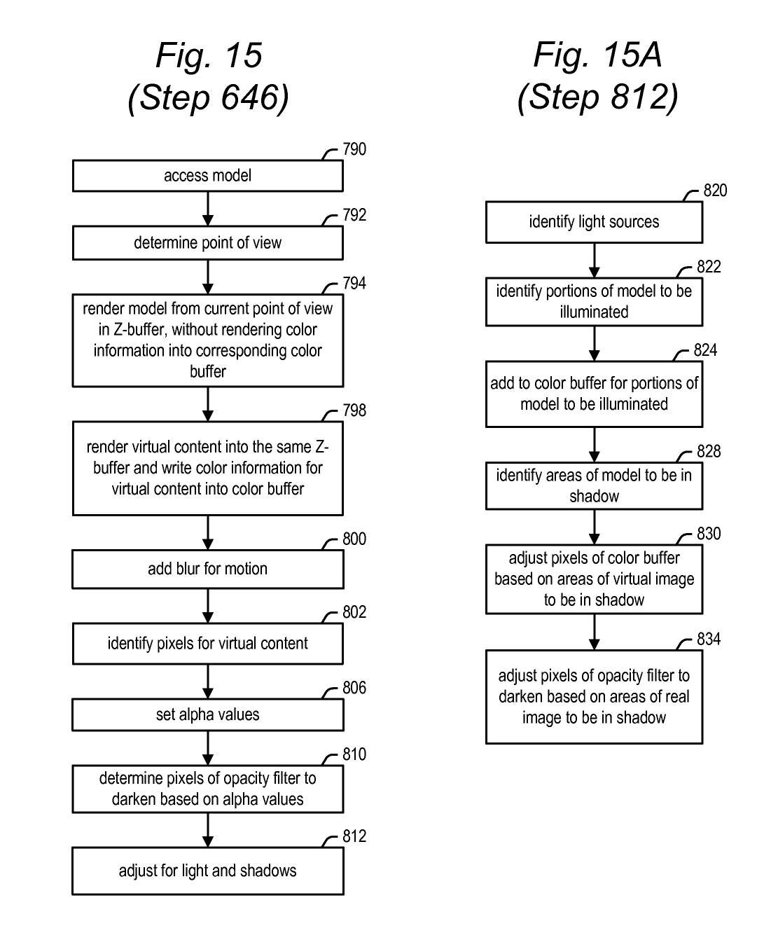

Further details of the rendering step 646 are now described with reference to the flowchart of FIGS. 15 and 15A. In step 790 of FIG. 15, the processing unit 4 accesses the model of the environment. In step 792, the processing unit 4 determines the point of view of the user with respect to the model of the environment. That is, the system determines what portion of the environment or space the user is look at. In one embodiment, step 792 is a collaborative effort using hub computing device 12, processing unit 4 and head mounted display device 2 as described above.

In one embodiment, the processing unit 4 will attempt to add multiple virtual objects into a scene. In other embodiments, the unit 4 may attempt to insert one virtual object into the scene. For a virtual object, the system has a target of where to insert the virtual object. In one embodiment, the target could be a real world object, such that the virtual object will be tagged to and augment the view of the real object. In other embodiments, the target for the virtual object can be in relation to a real world object.

In step 794, the system renders the previously created three dimensional model of the environment from the point of view of the user of head mounted display device 2 in a z-buffer, without rendering any color information into the corresponding color buffer. This effectively leaves the rendered image of the environment to be all black, but does store the z (depth) data for the objects in the environment. Step 794 results in a depth value being stored for each pixel (or for a subset of pixels). In step 798, virtual content (e.g., virtual images corresponding to virtual objects) is rendered into the same z-buffer and the color information for the color channel being determined is written into the corresponding color buffer. As noted, in embodiments, this may be green, red or blue, though it may be other colors in further embodiments. This effectively allows the virtual images to be drawn on the headset microdisplay 120 taking into account real world objects or other virtual objects occluding all or part of a virtual object.

In step 800, virtual objects being drawn over or tagged to moving objects may be blurred just enough to give the appearance of motion. In step 802, the system identifies the pixels of microdisplay 120 that display virtual images. In step 806, alpha values are determined for the pixels of microdisplay 120. In traditional chroma key systems, the alpha value is used to identify how opaque an image is, on a pixel-by-pixel basis. In some applications, the alpha value can be binary (e.g., on or off). In other applications, the alpha value can be a number with a range. In one example, each pixel identified in step 802 will have a first alpha value and all other pixels will have a second alpha value.

In step 810, the pixels for the opacity filter are determined based on the alpha values. In one example, the opacity filter has the same resolution as microdisplay 120 and, therefore, the opacity filter can be controlled using the alpha values. In another embodiment, the opacity filter has a different resolution than microdisplay 120 and, therefore, the data used to darken or not darken the opacity filter will be derived from the alpha value by using any of various mathematical algorithms for converting between resolutions. Other means for deriving the control data for the opacity filter based on the alpha values (or other data) can also be used.

In step 812, the images in the z-buffer and color buffer, as well as the alpha values and the control data for the opacity filter, are adjusted to account for light sources (virtual or real) and shadows (virtual or real). More details of step 812 are provided below with respect to FIG. 15A. The process of FIG. 15 allows for automatically displaying a virtual image over a stationary or moving object (or in relation to a stationary or moving object) on a display that allows actual direct viewing of at least a portion of the space through the display.

FIG. 15A is a flowchart describing one embodiment of a process for accounting for light sources and shadows, which is an example implementation of step 812 of FIG. 15. In step 820, processing unit 4 identifies one or more light sources that need to be accounted for. For example, a real light source may need to be accounted for when drawing a virtual image. If the system is adding a virtual light source to the user's view, then the effect of that virtual light source can be accounted for in the head mounted display device 2 as well. In step 822, the portions of the model (including virtual objects) that are illuminated by the light source are identified. In step 824, an image depicting the illumination is added to the color buffer described above.

In step 828, processing unit 4 identifies one or more areas of shadow that need to be added by the head mounted display device 2. For example, if a virtual object is added to an area in a shadow, then the shadow needs to be accounted for when drawing the virtual object by adjusting the color buffer in step 830. If a virtual shadow is to be added where there is no virtual object, then the pixels of opacity filter 114 that correspond to the location of the virtual shadow are darkened in step 834.

Referring again to the flowchart of FIG. 9, as noted above, predictions may generally be more accurate the less into the future they extend. Therefore, in addition to (or instead of) the extrapolation step 632, the color channel image data may be reprojected in a step 648. As noted above, in some examples, the extrapolation step 632 may use a single time in the future, for example t₂ which is then used in the extrapolation and render steps. In other examples, the extrapolation step 632 may use different times for different color channels, for example t₂, t₃ and t₄, which are then used in the extrapolation and render steps. Regardless, in embodiments which display the different color channels at different times, the step 648 may reproject the image data for each color channel separately. Thus, the color image data for sub-frame 1 may be reprojected to its estimated display time of t₂. The color image data for sub-frame 2 may be reprojected to its estimated display time of t₃. And the color image data for sub-frame 3 may be reprojected to its estimated display time of t₄. It is conceivable in further embodiments that the extrapolation step 632 be omitted given the reprojection step 648.

In reprojecting the color channel image data in step 648, the processing unit 4 may apply a transform to the data based on the extrapolation to adjust the color channel image data for each sub-frame from its current state to the extrapolated display times at t₂, t₃ and t₄ for the respective color channels. That is, at step 648, or each time through the steps shown in FIG. 9, the reprojection of step 648 may be applied to a different color channel sub-frame, so that when determining the first color channel, the reprojection may be from the image data at t₁ to the image data at t₂; when determining the second color channel, the reprojection may be from the image data at t₁ to the image data at t₃; and when determining the third color channel, the reprojection may be from the image data at t₁ to the image data at t₄. A variety of transforms may be applied for the reprojection step 636.

In one transform example, the processing unit 4 and/or hub 12 can determine integer offsets to adjust the color channel image data for each color channel from its state at determination to the extrapolated state at the time of display. As one method of implementation, the integer offsets can be encoded into initial pixels, such as the first two pixels or first line of pixels, of the sub-frame images. The integer offsets in each sub-frame may be a two digit number, with each digit representing an eight bit signed integer (ranging from −128 to 127), though the integer values may have a larger or smaller range in further embodiments. The first digit may represent the number of pixels to adjust each pixel in the image horizontally, and the second digit may represent the number of pixels to adjust each pixel the image vertically. These horizontal and vertical integer offsets may be generated for each color channel sub-frame and, as indicated above, for each of the left eye and right eye independently of each other.

A wide variety of other transforms are contemplated. Another computationally inexpensive transform is the same as above, but using non-integer values. In further embodiments, a variety of different transformation matrices may be derived to adjust the color channel image data for each sub-frame from that determined at time t₁ to the extrapolated display times t₂, t₃ and t₄. These transformation matrices may accomplish translation and/or rotation, affine transformations and/or homographic transformations. In further embodiments, the transformation may use any of various meshed-based warping algorithms, possibly including distortion compensation, known for transforming and warping image data. It is also contemplated that some hybrid transform be applied using two or more of the above-described transforms. Other types of transformations and transformation matrices may be applied to the color channel sub-frame image data to adjust the color channel image data for each color channel sub-frame from that determined at time t₁ to the extrapolated display times t₂, t₃ and t₄. The processing unit may cycle through its steps one or more times for each color channel sub-frame, updating the extrapolation for each color channel sub-frame to narrow the possible solutions as the time within a frame to display the final FOV approaches.

In step 650, the processing unit checks if information for the current frame has been determined for one of the color channel sub-frames i and it is time to send a rendered image for that color sub-frame to the head mounted display device 2. Alternatively, there may still time within the frame for further refinement of the extrapolated prediction using more recent position feedback data from the hub 12 and/or head mounted display device 2.

If it is time to display a color channel image in a sub-frame, the image based on the z-buffer and color buffer for that sub-frame is sent to microdisplay 120. That is, the virtual image is sent to microdisplay 120 to be displayed at the appropriate pixels, accounting for perspective and occlusions. At this time, the control data for the opacity filter is also transmitted from processing unit 4 to head mounted display device 2 to control opacity filter 114. The head mounted display would then display the image to the user in step 658. The above-described steps are repeated so that each of the color channel sub-frames is displayed in succession. If the processing unit has correctly predicted the FOV and object positions, then all three color channel sub-frames align with each other to present a single coherent and integrated full color image.

On the other hand, where it is not yet time to send a sub-frame of image data to be displayed in step 650, the processing unit may loop back for more updated data to further refine the predictions of the final FOV and the final positions of objects in the FOV. In particular, if there is still time in step 650, the processing unit 4 may return to step 608 to get more recent sensor data from the hub 12, and may return to step 656 to get more recent sensor data from the head mounted display device 2. Each successive time through the loop of steps 632 through 650, the extrapolations and/or reprojections performed uses a smaller time period into the future. As the time period over which data is extrapolated becomes smaller (X decreases), the extrapolations of the final FOV and object positions at the time of display become more predictable and accurate.

The processing steps 630 through 652 are described above by way of example only. It is understood that one or more of these steps may be omitted in further embodiments, the steps may be performed in differing order, or additional steps may be added. Additionally, in embodiments, the processing steps 630 through 652 may be performed entirely for the first color channel; then, after completion, performed again for the second color channel; then, after completion, performed again for the third color channel. In further embodiments, the performance of the steps 630 through 652 for the respective color channels may overlap.

In one further embodiment, instead of the respective color channels being displayed in successive time periods t₂, t₃ and t₄, each of the channels may be displayed simultaneously, so that t₂=t₃=t₄. In such an embodiment, the reprojection step 648 may reproject all of the color channels together at the same time. Moreover, while embodiments of the present technology have been described in the context of sequential color displays have respective color channels, it is understood that the present technology may be used in systems other than those employing sequential color displays. In such embodiments, the extrapolation step 632 and/or reprojection step 648 may be used to reduce latency and/or increase apparent frame-rate where input images arrive at a frame-rate lower than the display's frame rate.

Moreover, the flowchart of the processor unit steps in FIG. 9 shows all data from the hub 12 and head mounted display device 2 being cyclically provided to the processing unit 4 at the single step 632. However, it is understood that the processing unit 4 may receive data updates from the different sensors of the hub 12 and head mounted display device 2 asynchronously at different times. The head mounted display device 2 may provide image data from cameras 112 and inertial data from IMU 132. Sampling of data from these sensors may occur at different rates and may be sent to the processing unit 4 at different times. Similarly, processed data from the hub 12 may be sent to the processing unit 4 at a time and with a periodicity that is different than data from both the cameras 112 and IMU 132. In general, the processing unit 4 may asynchronously receive updated data multiple times from the hub 12 and head mounted display device 2 during a frame. As the processing unit cycles through its steps, it uses the most recent data it has received when extrapolating the final predictions of FOV and object positions.

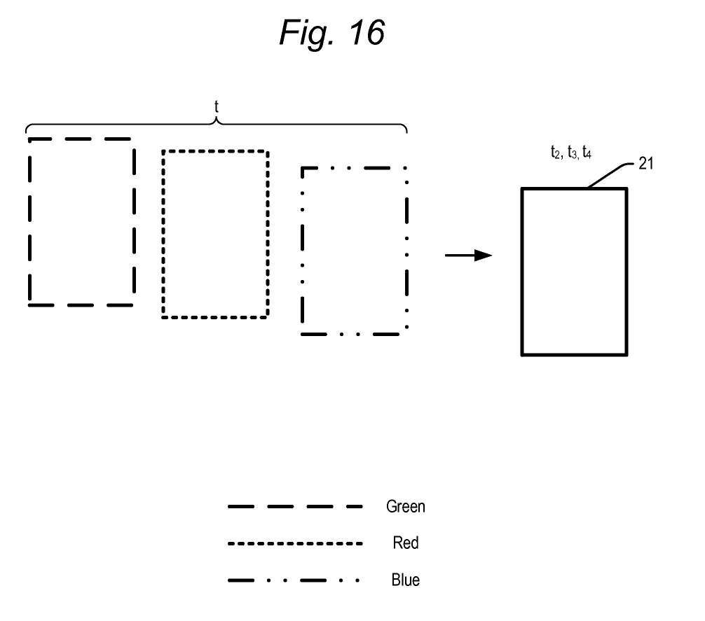

FIG. 16 is an illustration of image data for a virtual rectangle for three different color channels green, red and blue. Given movement of the user's head, the image data generated for the three different colors does not align at a time, t, prior to the extrapolation and/or reprojection steps. However, given the predictive and transform operations described above, the image data for the three color channels may corrected (horizontally and vertically in this example) and properly be displayed at a times t₂, t₃ and t₄ as a single, cohesive and integrated color virtual object 21.

It may be that a virtual object, such as virtual object 21 in FIG. 16 is registered to a real world object. In such embodiments, the real world object will be seen by the user at its correct and actual position in the FOV at time t₄ as the user moves his head. Using the above-described steps, the virtual object 21 will also be displayed in its correct and registered position with respect to the real world object at times t₂, t₃ and t₄.

In further embodiments, a virtual object 21 will not be registered to a real world object. In such embodiments, the image data for the respective color channels may be predicted and transformed as described above. However, in an embodiment where the virtual object 21 is not registered to a real world object, there is another option. Instead of predicting position at a later time of display, the known position of a virtual object in one of the color channel sub-frames may be used as an anchor position, and the remaining color channel sub-frames transformed to match the known position of the anchor color channel.

For example, the image data for the first color channel may be displayed at a time t₁. Instead of predicting a corrected position of the image data for the second and third color channels at a later time, the image data for the second and third color channels may be determined, and then adjusted by any of the transforms described above to align with the image data of the first color channel. Thus, at display, the virtual image 21 will display as a cohesive and integrated color image. While this position may not be the position of image data for the color channels if they were calculated at the times t₂, t₃ and t₄ at display of the respective color channels, as the virtual object is not tied to a real world object and this disparity may not be noticeable.

FIGS. 17 and 18 and illustrate a further feature of the present system mentioned above. In embodiments described above, for example in step 632 of FIG. 9, the processing unit 4 for a given user extrapolated the position of the final FOV at a time of display. Then, any virtual objects in the extrapolated FOV were rendered in step 646. In the embodiment of FIG. 17, instead of merely extrapolating the final predicted FOV, the processing unit (or hub 12) adds a border 854 surrounding the FOV 840 to provide an expanded FOV 858. The size of the border 854 may vary in embodiments, but may be large enough to encompass a possible new FOV resulting from the user turning his head in any direction between any of the times t₁, t₂, t₃ and t₄.

In the embodiment of FIG. 17, the positions of any virtual objects within the FOV are extrapolated, as in step 640 described above. However, in this embodiment, all virtual objects within the expanded FOV 858 are considered in the extrapolation. Thus, in FIG. 17, the processing unit 4 would extrapolate the position of virtual object 860 in the expanded FOV 858 in addition to the virtual objects 862 in predicted FOV 840.

In the next subsequent time period, if a user turns his head, for example to the left, the FOV 840 will shift to the left (resulting in the positions of all virtual objects moving to the right with respect to the new FOV 840). This scenario is illustrated in FIG. 18. In this embodiment, instead of having to re-render all objects in the new FOV 840, all objects in the previous FOV 840 shown in FIG. 17 may be pixel-shifted by the determined distance change in the new FOV 840 position. Thus, the virtual objects 860 may be displayed in their proper position, shifted to the right, without having to re-render them. The rendering is for any area of the expanded FOV 858 that is newly included within the new FOV 840. Thus, the processing unit 4 would render the virtual image 862. Its position would already be known as it was included in the expanded FOV 858 from the previous time period.

Using the embodiment described in FIGS. 17 and 18, an updated display of the user FOV may be generated quickly by having to render just a slice of the image and re-using the rest of the image from the previous time period. Thus, updated image data may be sent to the head mounted display device 2 to be displayed during a sub-frame effectively increasing the sub-frame generation rate.

In the embodiments described above, the entirety of image data in a given color channel sub-frame may be corrected by the applied transform to the predicted position at the time of display. However, in a further embodiment, discrete virtual images within an FOV may be handled differently with some in the FOV possibly being corrected while others in the FOV might not. This concept is referred to herein as compositing. As one example, an FOV may include head-locked virtual objects and scene-locked virtual objects. As the position of head-locked virtual objects remains stationary within the user's FOV, these virtual objects are not given to color break-up upon head movement, and do not need to be corrected and transformed as described above.

Using compositing, the hub 12 and/or processing unit 4 are able to identify pixels for virtual objects within color channels which may be corrected, such as for example scene locked virtual objects and dynamically moving virtual objects, as opposed to virtual objects within color channels which do not need to be corrected, such as scene-locked virtual objects. As indicated above, the system may store whether an object is scene-locked, head-locked or dynamically moving, and is able to identify the pixels corresponding to those virtual objects in a color channel sub-frame. For scene-locked and dynamically moving virtual objects, the system can extrapolate the final position of such objects within the FOV at the time of display. In this embodiment, the pixels for those virtual objects may be adjusted using a transform as described above. The pixels for head-locked virtual objects receive no adjustment.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A system for presenting a mixed reality experience, the system comprising:
a display device including a color sequential display for projecting a virtual object in two or more color channels;
a sensor for sensing positions of the display device; and
one or more processors for determining image data for the virtual object on each of the two or more color channels for the color sequential display to project the virtual object, the one or more processors predicting a position of the display device at one or more times the color sequential display is to project the virtual object based on input from the sensor, the one or more processors adjusting the image data for the virtual object on first and second color channels of the two or more color channels, independently of each other, based on the predicted position of the display device at the one or more times the color sequential display is to display the virtual object.

2. The system of claim 1, the one or more processors adjusting the image data for the first and second color channels to align with each other at the one or more times the color sequential display is to display the two or more color channels.

3. The system of claim 1, the one or more processors applying a transform to the image data to adjust the image data based on the predicted position of the sensor at the one or more times the color sequential display is to display the two or more color channels.

4. The system of claim 3, the applied transform being one of an integer pixel offset transform, an affine transform, a homography transform and a meshed-based warping algorithm.

5. The system of claim 1, the one or more processors performing the prediction of the position of the display device two or more times between a first refresh of the projected image by the color sequential display and a second immediately subsequent refresh of the projected image by the color sequential display.

6. The system of claim 1, the one or more processors adjusting the image data for each of the first and second color channels two or more times between a first refresh of the projected image by the color sequential display and a second immediately subsequent refresh of the projected image by the color sequential display.

7. The system of claim 1, wherein the sensor comprises an image capture device sensing a position of the display device.

8. The system of claim 1, wherein the sensor comprises an inertial measurement unit sensing movement of the display device.

9. The system of claim 1, wherein the virtual object is registered to a real world object in a field of view of the display device.

10. A system for presenting a mixed reality experience, the system comprising:
a head mounted display device including a color sequential display for projecting a virtual object using first, second and third color channels;
a plurality of sensors for sensing positions of the display device, the plurality of sensors comprising an inertial measurement unit for sensing movement of the head mounted display device and at least one image capture device; and
one or more processors for determining a three-dimensional map of the environment in which the system is used based on data from the plurality of sensors, the one or more processors rendering the first, second and third color channels at a time t₁, the one or more processors predicting a position of the display device at a time t₂, after t₁, when the color sequential display is to display the first color channel, the one or more processors predicting a position of the display device at a time t₃, after t₂, when the color sequential display is to display the second color channel, the one or more processors predicting a position of the display device at a time t₄, after t₃, when the color sequential display is to display the third color channel, the one or more processors adjusting the image data for the virtual object on the first, second and third color channels, independently of each other, based on the predicted position of the display device at the times t₂, t₃ and t₄.

11. The system of claim 10, the virtual object comprising a first virtual object, the one or more processors determining a position at which to project a second virtual object, the one or more processors not adjusting the determined position of the image data for the second virtual object prior to display of the first and second virtual objects.

12. The system of claim 11, wherein the first virtual object is one of a scene-locked virtual object and a dynamic virtual object, and the second virtual object is a head-locked virtual object.

13. The system of claim 10, wherein data indicating the adjustment of the image data for the first, second and third color channels is encoded into initial pixels of the images for the first, second and third color channels.

14. The system of claim 10, the one or more processors adjusting the image data for the first, second and third color channels to align with each other when the respective color channels are displayed at the times t₂, t₃ and t₄.

15. The system of claim 10, the one or more processors applying one of an integer pixel offset transform, an affine transform, a homography transform and a meshed-based warping algorithm to adjust the image data of the respective color channels based on the predicted positions of the sensor at the times t₂, t₃ and t₄.

16. A method of displaying an image using a display device including a color sequential display, the method comprising:
(a) determining a view of the display device;
(b) rendering image data based on the view determined in said step (a);
(c) predicting an updated view of the display device after said step (a); and
(d) applying one or more transforms to image data for color channels of the color sequential display to adjust the image data for the color channels based on the updated view predicted in said step (c), image data for a first color channel adjusted differently than image data for a second color channel.

17. The method of claim 16, said step (c) of predicting the updated view of the display device comprising the step of predicting the updated view of the display device at a time when the display device is to display the image from a color channel.

18. The method of claim 16, said step (c) of predicting the updated view of the display device comprising the step of using previous positions of the display device and movement of the display device to extrapolate a position of the display device at a time when the display device is to display the image from a color channel.

19. The method of claim 16, said step (d) of applying one or more transforms to adjust the image data for the respective color channels so that the color channels display images at one or more times that fuse into a single cohesive color image.

20. The method of claim 16, said step (b) of rendering the image comprises the step of rendering virtual objects for display on a display in a system for presenting a mixed reality experience.
